(19) United States
(12) Patent Application Publication
(10) Pub. No.: US 2025/0310773 A1
(43) Pub. Date: Oct. 2, 2025

(54) PRIVILEGE INFORMATION ISSUING APPARATUS, SYSTEM, AND METHOD, AND COMPUTER READABLE MEDIUM

(71) Applicant: NEC CORPORATION, Minato-ku, Tokyo (JP)

(72) Inventors: Eri KOKAJI, Tokyo (JP); Kazufumi HOSHI, Tokyo (JP); Yurie HOSHI, Tokyo (JP); Hiroaki KUJIRAI, Tokyo (JP)

(73) Assignee: NEC CORPORATION, Minato-ku, Tokyo (JP)

(21) Appl. No.: 18/864,595

(22) PCT Filed: Jul. 28, 2022
(86) PCT No.: PCT/JP2022/029078

§ 371 Date: Nov. 11, 2024

(51) Int. Cl. H04W 12/61; H04W 12/06; H04W 12/64

(52) U.S. Cl. CPC H04W 12/61; H04W 12/06; H04W 12/64

(57) ABSTRACT

A privilege information issuing apparatus according to the present invention includes; a storage unit that stores entry qualification information with which a user is able to enter an event venue through identity authentication, identity authentication information of the user who has purchased the entry qualification information, and a user terminal that the user carries with himself/herself in an associated manner; an issuing unit that sets a validity period based on an end time of a predetermined event and issues privilege information that is able to be used in facilities in a neighborhood of the event venue where the event has been held; and a notification unit that notifies a terminal of the user who has entered the event venue through identity notification of the issued privilege information at a timing that is attributable to an end time.

### TECHNICAL FIELD

The present disclosure relates to a privilege information issuing apparatus, a system, a method, and a program.

### BACKGROUND ART

Patent Literature 1 discloses a technology related to a congestion mitigation apparatus that determines an attraction to be held in an attraction venue on a route from a stadium (departure point) to a station (destination point) after an event held in the stadium ends. Patent Literature 2 discloses a technology related to an information processing device for efficiently alleviating congestion in a transportation station in an event facility.

Here, a unique economic zone can be formed in a predetermined region including an event venue and commercial facilities around the event venue. In addition, management of entry to an event venue using identity authentication such as biometric authentication including face authentication has been put into practical use in recent years.

### CITATION LIST

### Patent Literature

Patent Literature 1: Japanese Unexamined Patent Application Publication No. 2016-042275
Patent Literature 2: Japanese Unexamined Patent Application Publication No. 2022-019414

### SUMMARY OF INVENTION

### Technical Problem

Here, alleviating congestion by encouraging people who are returning home after an end of an event to use commercial facilities in the surroundings and dispersing returning timings is conceivable. There is room for improvement in a way of specifying a target of congestion alleviation in the technologies according to Patent Literature 1 and 2 described above.

In view of the above-described task, an object of the present disclosure is to provide a privilege information issuing apparatus, a system, a method, and a program to encourage users who have entered an event venue through identity authentication to use facilities in surroundings thereof before and after an end of an event, disperse returning timings, and support alleviation of congestion of people who are returning home.

### Solution to Problem

A privilege information issuing apparatus according to the present disclosure includes: an issuing means for setting a validity period based on an end time of a predetermined event and issuing privilege information that is able to be used in facilities in a neighborhood of an event venue where the event has been held; and a notification means for notifying a terminal of a user who has entered the event venue through identity authentication of the issued privilege information at a timing that is attributable to the end time.

A privilege information issuing system according to the present disclosure includes:
a storage apparatus that stores entry qualification information with which a user is able to enter an event venue through identity authentication, identity authentication information of the user who has purchased the entry qualification information, and a user terminal that the user carries with himself/herself in an associated manner; and
a privilege information issuing apparatus that is connected to the storage apparatus,
in which the privilege information issuing apparatus includes
an issuing means for setting a validity period based on an end time of a predetermined event and issuing privilege information that is able to be used in facilities in a neighborhood of the event venue where the event has been held, and
a notification means for notifying a user terminal associated with the user who has entered the event venue through identity authentication performed with reference to the storage apparatus of the issued privilege information at a timing that is attributable to the end time.

A privilege information issuing method according to the present disclosure includes,
by a computer:
setting a validity period based on an end time of a predetermined event and issuing privilege information that is able to be used in facilities in a neighborhood of an event venue where the event has been held; and
notifying a terminal of a user who has entered the event venue through identity authentication of the issued privilege information at a timing that is attributable to the end time.

A privilege information issuing program according to the present disclosure causes a computer to execute:
an issuing means for setting a validity period based on an end time of a predetermined event and issuing privilege information that is able to be used in facilities in a neighborhood of an event venue where the event has been held; and
a notification means for notifying a terminal of a user who has entered the event venue through identity authentication of the issued privilege information at a timing that is attributable to the end time.

### Advantageous Effects of Invention

According to the present disclosure, it is possible to provide a privilege information issuing apparatus, a system, a method, and a program to encourage users who have entered an event venue through identity authentication to use facilities in surroundings before and after an end of an event, disperse returning timings, and support alleviation of congestion of people who are returning home.

### BRIEF DESCRIPTION OF DRAWINGS

FIG. 1 is a block diagram illustrating a configuration of a privilege information issuing apparatus according to a first example embodiment.

FIG. 2 is a flowchart illustrating a flow of a privilege information issuing method according to the first example embodiment.

FIG. 3 is a block diagram illustrating an overall configuration of a privilege information issuing system according to a second example embodiment.

FIG. 4 is a block diagram illustrating a configuration of an authentication apparatus according to the second example embodiment.

FIG. 5 is a block diagram illustrating a configuration of a user terminal according to the second example embodiment.

FIG. 6 is a block diagram illustrating a configuration of an entry control terminal according to the second example embodiment.

FIG. 7 is a block diagram illustrating a configuration of a payment terminal according to the second example embodiment.

FIG. 8 is a block diagram illustrating a configuration of a privilege information issuing apparatus according to the second example embodiment.

FIG. 9 is a flowchart illustrating a flow of member information registration processing according to the second example embodiment.

FIG. 10 is a flowchart illustrating a flow of face information registration processing performed by the authentication apparatus according to the second example embodiment.

FIG. 11 is a sequence diagram illustrating a flow of entry qualification information registration processing according to the second example embodiment.

FIG. 12 is a flowchart illustrating a flow of face authentication processing performed by the authentication apparatus according to the second example embodiment.

FIG. 13 is a flowchart illustrating a flow of privilege information issuing processing according to the second example embodiment.

FIG. 14 is a diagram illustrating a display example of privilege information according to the second example embodiment.

FIG. 15 is a flowchart illustrating a flow of privilege information issuing processing according to a third example embodiment.

FIG. 16 is a flowchart illustrating a flow of the privilege information issuing processing according to the third example embodiment.

FIG. 17 is a diagram illustrating a display example of privilege information according to the third example embodiment.

FIG. 18 is a diagram illustrating a display example of privilege information according to the third example embodiment.

FIG. 19 is a diagram illustrating a display example of privilege information according to the third example embodiment.

FIG. 20 is a flowchart illustrating a flow of privilege information issuing processing according to a fourth example embodiment.

FIG. 21 is a diagram illustrating a display example of privilege information according to the fourth example embodiment.

FIG. 22 is a flowchart illustrating a flow of privilege information issuing processing according to a fifth example embodiment.

FIG. 23 is a diagram illustrating a display example of privilege information according to a fifth example embodiment.

FIG. 24 is a flowchart illustrating a flow of privilege information issuing processing according to a sixth example embodiment.

FIG. 25 is a diagram illustrating a display example of privilege information according to a sixth example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated descriptions will be omitted as necessary for clarity of description.

### First Example Embodiment

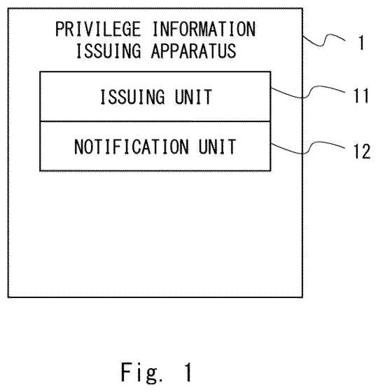

FIG. 1 is a block diagram illustrating a configuration of a privilege information issuing apparatus 1 according to a first example embodiment. The privilege information issuing apparatus 1 is an information processing apparatus that issues privilege information that can be used in predetermined commercial facilities. Here, the “facilities” are stores, accommodation facilities, public transportation stations, and the like that conduct product sales, service provisions, and the like. The facilities according to the first example embodiment are assumed to be present in a region within a predetermined range from an event venue where a predetermined event is held, that is, in the neighborhood of the event venue. In addition, the “privilege information” is electronic data to which a right to enjoy a paid privilege or a free privilege in an available facility has been given. The privilege information is, for example, value added information such as an electronic coupon or a point.

The privilege information issuing apparatus 1 includes an issuing unit 11 and a notification unit 12. The issuing unit 11 sets a validity period based on an end time of a predetermined event and issues privilege information that can be used in facilities in the neighborhood of the event venue where the event has been held. The notification unit 12 notifies a terminal of a user who has entered the event venue through identity authentication of the issued privilege information at a timing that is attributable to an end time. Here, the “identity authentication” is information processing of verifying authenticity of an individual by collating identity authentication information registered in advance with information acquired from the individual or input from the individual at the time of the authentication and determining that a degree of matching is equal to or greater than a threshold value. Although examples of the identity authentication include biometric authentication such as face authentication, collation of code information (such as an ID or a password) presented or input by the individual, and the like, the identity authentication is not limited thereto.

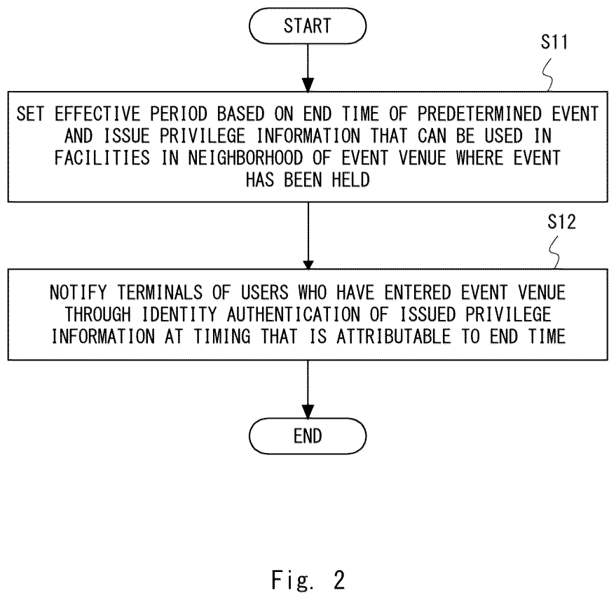

FIG. 2 is a flowchart illustrating a flow of privilege information issuing method according to the first example embodiment. First, the issuing unit 11 sets a validity period based on an end time of a predetermined event and issues privilege information that can be used in facilities in the neighborhood of an event venue where the event has been held (S11). Next, the notification unit 12 notifies a terminal of a user who has entered the event venue through identity authentication of the privilege information issued in Step S11 at a timing that is attributable to an end time (S12).

In this manner, the user who has entered the event venue through the identity authentication can easily recognize the privilege information provided through the notification to the terminal of the user himself/herself before or after an end of the event. Therefore, the user who has received the notification of the privilege information is motivated to drop by at the facilities in the neighborhood during travel from the event venue before or after the end of the event and perform a consumption action. It is thus possible to encourage the user who has entered the event venue through identity authentication to use the facilities in the surroundings before or after the end of the event, to disperse returning timings, and to support alleviation of congestion of people who are turning home. Note that the issuing unit 11 may set a validity period based on a start time of the predetermined event. This enables human flow control before the start of the event.

Note that the privilege information issuing apparatus 1 includes a processor, a memory, and a storage apparatus as configurations, which are not illustrated. In addition, the storage apparatus stores a computer program that implements processing of the privilege information issuing method according to the present example embodiment. Then, the processor reads a computer program or the like from the storage apparatus into the memory and executes the computer program. In this manner, the processor implements the functions of the issuing unit 11 and the notification unit 12.

Alternatively, each component of the privilege information issuing apparatus 1 may be implemented by dedicated hardware. In addition, some or all of the components of each apparatus may be implemented by general-purpose or dedicated circuitry, a processor, or a combination thereof. These may be configured of a single chip or may be configured of a plurality of chips connected via a bus. Some or all of the components of each apparatus may be implemented by a combination of the aforementioned circuitry or the like and a program. Furthermore, as the processor, a central processing unit (CPU), a graphics processing unit (GPU), a field-programmable gate array (FPGA), a quantum processor (quantum computer control chip), or the like can be used.

In a case where some or all of the components of the privilege information issuing apparatus 1 are implemented by a plurality of information processing apparatuses, circuits, or the like, the plurality of information processing apparatuses, circuits, or the like may be arranged in a centralized manner or in a distributed manner. For example, the information processing apparatuses, the circuits, or the like may be implemented in the form of a client server system, a cloud computing system, or the like in which they are connected to each other via a communication network. The functions of the privilege information issuing apparatus 1 may be provided in a software as a service (SaaS) format.

### Second Example Embodiment

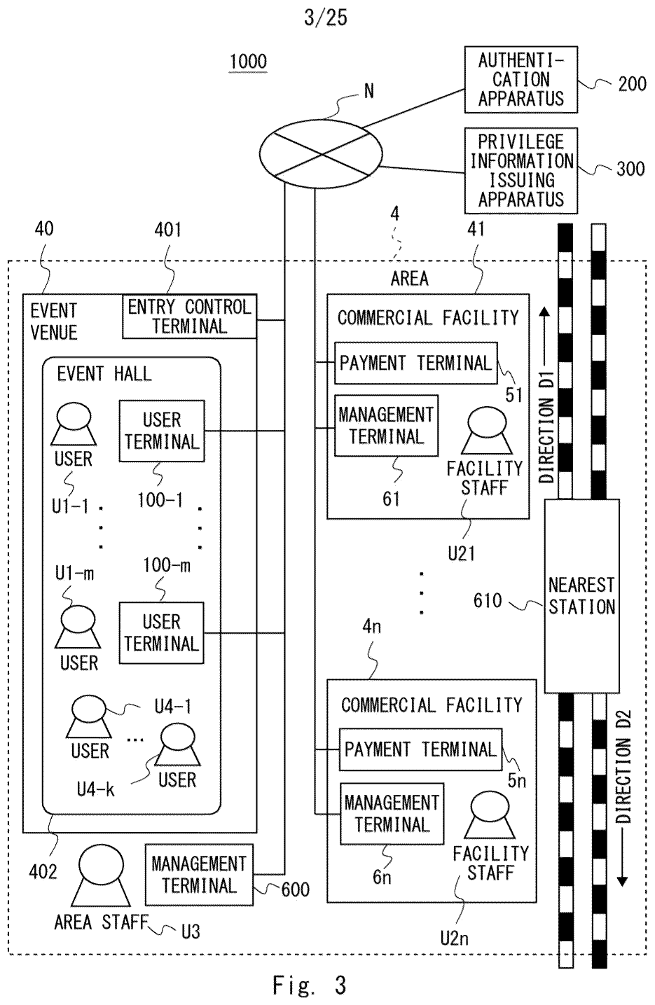

A second example embodiment is a specific example of the first example embodiment described above. FIG. 3 is a block diagram illustrating an overall configuration of a privilege information issuing system 1000 according to the second example embodiment. The privilege information issuing system 1000 is an information system that issues, for users U1-1 to U1-m (m is a natural number that is equal to or greater than two) who have purchased paid electronic tickets (entry qualification information) of the event venue 40 and have entered the event venue 40, coupons that can be used in commercial facilities 41 and the like in the neighborhood after an end of the event and provides notifications to user terminals 100-1 to 100-m. It is thus possible to disperse returning timings at the time of the end of the event and to support alleviation of congestion at transportation facilities (the nearest station 610, for example). Additionally, it is possible to promote cooperative utilization of the event venue and the facilities and to support revitalization of an area 4 including the event venue 40 and commercial facilities 41 to 4n (n is a natural number that is equal to or greater than one) in the neighborhood thereof.

Note that, in the following description, the users U1-1 to U1-m may be simply referred to as “users U1”. Furthermore, since the user terminals 100-1 to 100-m have similar functions and configurations, the user terminals 100-1 to 100-m may be simply referred to as “user terminals 100” in the following description. Note that, in the following description, users U4-1 to U4-k (k is a natural number that is equal to or greater than one) may be simply referred to as “users U4”.

The event venue 40 is a site where a predetermined event is held. The “event” is a paid service provided at a certain time by collecting a large number of people. For example, the event is a sport game, a concert, an exhibition, an international conference, a test, or the like, and may be watched or viewed by visitors who have made payment, or the visitors themselves may participate in the event. Therefore, the event venue 40 is a facility such as a sport stadium, a sport ground, an arena, a theater, or a multiuse event hall, for example. The event venue 40 can also be referred to as a main facility or a core facility in the area 4.

It is assumed that the event venue 40 includes an event hall 402 and an entry control terminal 401 is installed at an entrance. The entry control terminal 401 is an information terminal that permits entry to the event venue 40 in a case where the user U1 has succeeded in the person authentication. Details of the entry control terminal 401 will be described later. Note that it is assumed that there may be the users U4 who have entered the event venue 40 without intervention of the entry control terminal 401 among people who enter the event venue 40. In other words, the event venue 40 may allow entry of the users U4 who have purchased conventional tickets or the like without identity authentication such as face authentication. The event hall 402 is a place where an event is held, a sport ground, an audience seat, or the like.

The commercial facilities 41 to 4n and the nearest station 610 are facilities in the surroundings and neighborhood of the event venue 40. The number of commercial facilities 41 and the like may be at least one or more. The commercial facility 41 and the like are facilities in a cooperative relationship with the side of the event venue 40. Therefore, business operators of the commercial facility 41 and the like are business partners of a business operator on the side of the event venue 40. Examples of the commercial facility 41 and the like include, but are not limited to, retail stores, restaurants, shopping streets, shopping malls, accommodation facilities, parking lots, bicycle parking spaces, transportation stations (railway stations, bus stops, taxi lanes, ports, airports), amusement parks, and the like.

In each of the commercial facilities 41 to 4n, at least each of payment terminals 51 to 5n compatible with the payment using face authentication is installed. In addition, each of the facility staff U21 to U2n performs a management operation such as registration and the like of privilege information that can be used in each of the commercial facilities 41 to 4n using each of management terminals 61 to 6n. The facility staff U21 and the like may also be shop staff of the commercial facility 41 and the like. Alternatively, the facility staff U21 and the like may be a cooperative business operator on the side of the commercial facility 41 and the like. Therefore, the facility staff U21 and the like and the management terminal 61 and the like may not necessarily be present inside the commercial facility 41 and the like.

The nearest station 610 is a public transportation station that is nearest to the event venue 40 and is, for example, a railway station. It is assumed that the nearest station 610 allows arrival and departure of different routes in directions D1 and D2, for example. A public transportation that operates the nearest station 610 may be a business partner with a business operator on the side of the event venue 40. In that case, an automatic ticket gate or the like installed at the nearest station 610 is a payment terminal (not illustrated) having a function that is similar to that of the payment terminal 51 or the like.

An area staff U3 is a business operator who manages business operations inside the area 4 including the event venue 40, the commercial facility 41, and the like. The area staff U3 may register the privilege information that can be used in the commercial facility 41 and the like using the management terminal 600. Note that since it is possible to use known information processing apparatuses as the management terminals 61 to 6n and 600, illustration and detailed description will be omitted.

Here, the privilege information issuing system 1000 includes the user terminal 100, an authentication apparatus 200, a privilege information issuing apparatus 300, an entry control terminal 401, payment terminals 51 to 5n, and the management terminals 61 to 6n and 600. Each of the user terminal 100, the authentication apparatus 200, the privilege information issuing apparatus 300, the entry control terminal 401, the payment terminals 51 to 5n, and the management terminals 61 to 6n and 600 is communicatively connected via the network N. Here, the network N is a communication network including a wireless communication line and is, for example, the Internet, a wireless communication line network, a mobile phone line network, or the like. The network N may be of any type of communication protocol.

The authentication apparatus 200 is an information processing apparatus that manages face feature information of the user and performs face authentication. In response to a face authentication request received from the outside, the authentication apparatus 200 collates a face image or face feature information included in the request with the face feature information of each user, and returns the collation result (authentication result) to the request source.

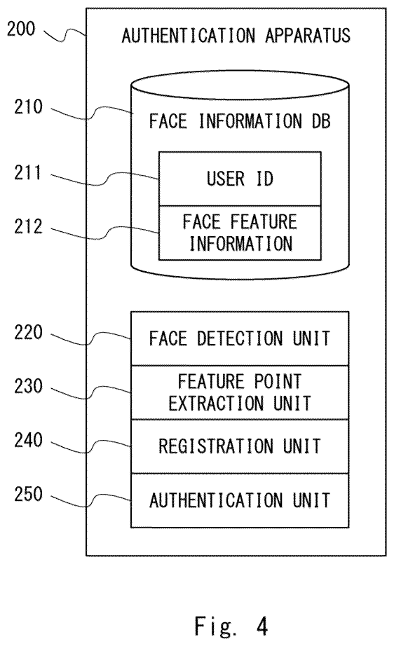

FIG. 4 is a block diagram illustrating the configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a set of feature points extracted from the face image. Note that the authentication apparatus 200 may delete the face feature information 212 in the face information DB 210 in response to a request from the user or the like corresponding to the face feature information 212. Alternatively, the authentication apparatus 200 may delete the face feature information 212 after elapse of a predetermined period from registration.

The face detection unit 220 detects a face region included in a registered image for registering face information, and outputs the face region to the feature point extraction unit 230. The feature point extraction unit 230 extracts feature points from the face region detected by the face detection unit 220, and outputs the face feature information to the registration unit 240. In addition, the feature point extraction unit 230 extracts feature points included in the face image received from the privilege information issuing apparatus 300 or the like, and outputs the face feature information to the authentication unit 250.

The registration unit 240 newly issues the user ID 211 at a time of registering the face feature information. The registration unit 240 registers the issued user ID 211 and the face feature information 212 extracted from the registered image in the face information DB 210 in association with each other.

The authentication unit 250 performs face authentication using the face feature information 212. Specifically, the authentication unit 250 collates the face feature information extracted from the face image with the face feature information 212 in the face information DB 210. If the collation is successful, the authentication unit 250 specifies the user ID 211 associated with the collated face feature information 212. The authentication unit 250 returns the matching result of the face feature information to the request source as a face authentication result. Whether or not the pieces of face feature information match each other corresponds to whether or not authentication has been successful or failed. Note that the fact that the pieces of face feature information match each other means that the degree of matching is equal to or greater than a threshold value. In addition, it is assumed that the face authentication result includes the specified user ID in a case where the face authentication has been successful.

Returning to FIG. 3, the description will be continued. The users U1-1 to U1-m carry the user terminals 100-1 to 100-m with themselves and operate the user terminals 100-1 to 100-m, respectively, are purchasers of entry qualification information of the event held in the event venue 40, and are people who have been allowed to enter the event venue 40 through face authentication and have entered the event venue 40. Here, the “entry qualification information” is information proving that the user can enter the event venue through identity authentication.

The user terminal 100 is an information processing terminal that registers user information including the face image and the entry qualification information in the privilege information issuing apparatus 300 in advance in accordance with an operation of the user U1. Note that the user U1 may perform registration and the like of the user information using an information processing apparatus other than the user terminal 100. Furthermore, it is assumed that the user U1 enters the event venue 40 with the user terminal 100 carried with the user.

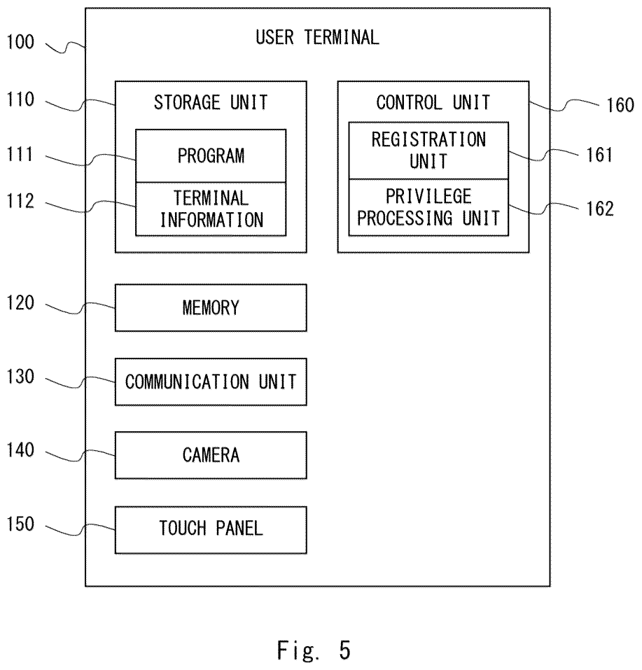

FIG. 5 is a block diagram illustrating a configuration of the user terminal 100 according to the second example embodiment. The user terminal 100 includes a storage unit 110, a memory 120, a communication unit 130, a camera 140, a touch panel 150, and a control unit 160. The storage unit 110 is an example of a nonvolatile storage device such as a flash memory. The storage unit 110 stores a program 111 and terminal information 112. The program 111 is a computer program in which processing such as registration of user information and entry qualification information, and inquiry, display, selection, and utilization of privilege information are mounted. The terminal information 112 is identification information and destination information of the user terminal 100.

The memory 120 is a volatile storage device such as a random access memory (RAM) and is a storage region for temporarily holding information during an operation of the control unit 160. The communication unit 130 is a communication interface with the network N.

The camera 140 is an imaging apparatus for imaging a region including the face of the user U1. The camera 140 outputs the captured image to the control unit 160. The touch panel 150 includes a display apparatus (display unit) such as a screen and an input apparatus.

The control unit 160 is a processor, that is, a control apparatus, that controls each configuration of the user terminal 100. The control unit 160 reads the program 111 from the storage unit 110 into the memory 120 and executes the program 111. In this manner, the control unit 160 implements the functions of the registration unit 161 and the privilege processing unit 162.

The registration unit 161 controls the camera 140, images the face of the user U1, and acquires the captured face image. Also, the registration unit 161 acquires attribute information and payment information input by the user U1 via the touch panel 150. In addition, the registration unit 161 reads and acquires the terminal information 112 from the storage unit 110. Then, the registration unit 161 transmits a registration request of the user information (member information) including the face image, the terminal information 112, the attribute information, and the payment information to the privilege information issuing apparatus 300. Furthermore, the registration unit 161 acquires entry qualification information purchased by the user U1. The registration unit 161 transmits a registration request including the face image of the user U1 and the entry qualification information to the privilege information issuing apparatus 300. Note that the registration unit 161 may include the entry qualification information in the registration request of the user information.

In response to a privilege issuing request provided through an instruction from the user U1 via the touch panel 150, the privilege processing unit 162 controls the camera 140, images the face of the user U1, and acquires the captured face image. Then, the privilege processing unit 162 may transmit a privilege issuing request including the face image to the privilege information issuing apparatus 300. Also, in a case where the privilege processing unit 162 receives a notification of privilege information issued from the privilege information issuing apparatus 300, the privilege processing unit 162 displays the privilege information and the like provided through the notification on the touch panel 150. In addition, the privilege processing unit 162 transmits a privilege information inquiry request including the face image of the user U1 to the privilege information issuing apparatus 300 in response to the privilege inquiry request provided through an instruction from the user U1 via the touch panel 150. Then, the privilege processing unit 162 displays, on the touch panel 150, a list of the privilege information that has already been issued from the privilege information issuing apparatus 300 for the user U1. The privilege processing unit 162 displays the privilege information selected by the user U1 via the touch panel 150 in a selected state. In a case where the privilege processing unit 162 receives a privilege information update notification from the privilege information issuing apparatus 300, the privilege processing unit 162 displays the privilege information after update on the touch panel 150.

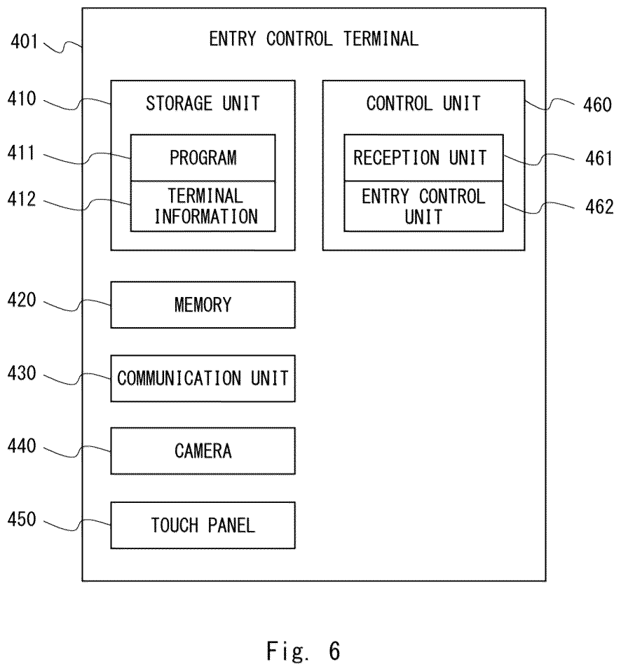

FIG. 6 is a block diagram illustrating a configuration of the entry control terminal 401 according to the second example embodiment. The entry control terminal 401 includes a storage unit 410, a memory 420, a communication unit 430, a camera 440, a touch panel 450, and a control unit 460. The storage unit 410 is an example of a nonvolatile storage device such as a flash memory. The storage unit 410 stores a program 411 and terminal information 412. The program 411 is a computer program in which the entry control processing and the like are mounted. The terminal information 412 is identification information and destination information of the entry control terminal 401.

The memory 420 is a volatile storage device such as a RAM, and is a storage region for temporarily holding information during operations of the control unit 460. The communication unit 430 is a communication interface with the network N.

The camera 440 is an imaging apparatus for imaging a region including a face of an entry scheduled person such as the user U1. The camera 440 outputs the captured image to the control unit 460. The touch panel 450 includes a display apparatus (display unit) such as a screen and an input apparatus.

The control unit 460 is a processor, that is, a control apparatus that controls each configuration of the entry control terminal 401. The control unit 460 reads the program 411 from the storage unit 410 into the memory 420 and executes the program 411. In this manner, the control unit 460 implements the functions of the reception unit 461 and the entry control unit 462.

The reception unit 461 receives the face image of the entry scheduled person captured by the camera 440 and outputs the face image to the entry control unit 462. The entry control unit 462 transmits an entry determination request including the face image output by the reception unit 461 and the terminal information 412 stored in the storage unit 110 to the privilege information issuing apparatus 300. Then, in a case where the entry control unit 462 receives an entry determination result from the privilege information issuing apparatus 300 and the entry determination result indicates permission of entry, the entry control unit 462 performs control to unlock an entrance gate (not illustrated) or the like of the event venue 40. Note that entry control terminal 401 may control an exit gate through face authentication at the time of exiting the site as well.

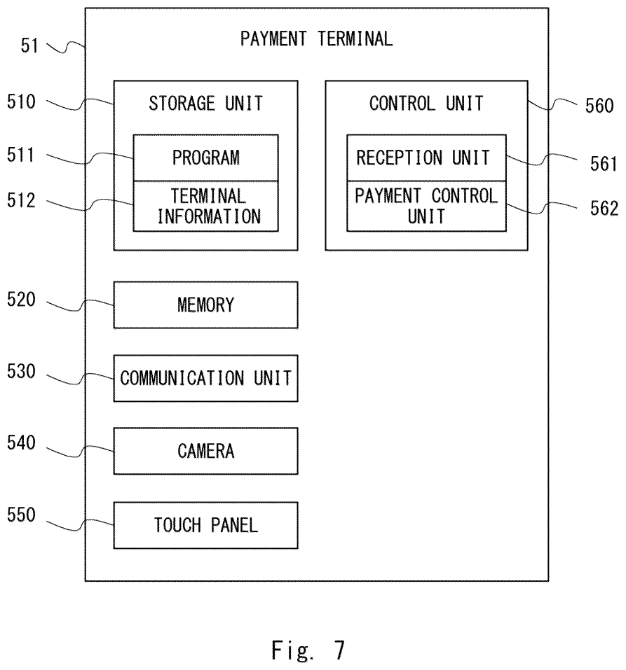

FIG. 7 is a block diagram illustrating a configuration of the payment terminal 51 according to the second example embodiment. Note that since the configurations of the payment terminal 5n and the like are similar to that of the payment terminal 51, illustration and detailed description will be omitted. The payment terminal 51 includes a storage unit 510, a memory 520, a communication unit 530, a camera 540, a touch panel 550, and a control unit 560. The storage unit 510 is an example of a nonvolatile storage device such as a flash memory. The storage unit 510 stores a program 511 and terminal information 512. The program 511 is a computer program in which payment control processing and the like are mounted. The terminal information 512 is identification information and destination information of the payment terminal 51. In addition, the terminal information 512 is assumed to be information with which the commercial facility 41 where the terminal is installed can be specified.

The memory 520 is a volatile storage device such as a RAM, and is a storage region for temporarily holding information during the operations of the control unit 560. The communication unit 530 is a communication interface with the network N.

The camera 540 is an imaging apparatus for imaging a region including a face of a person who makes payment such as the user U1. The camera 540 outputs the captured image to the control unit 560. The touch panel 550 includes a display apparatus (display unit) such as a screen and an input apparatus.

The control unit 560 is a processor, that is, a control apparatus that controls each configuration of the payment terminal 51. The control unit 560 reads the program 511 from the storage unit 510 into the memory 520 and executes the program 511. In this manner, the control unit 560 implements the functions of the reception unit 561 and the payment control unit 562.

The reception unit 561 receives an input of payment target information such as a price of a product for the person who makes payment will make a payment for. For example, the reception unit 561 receives, as payment target information, information read from a barcode on a product with a scanner (not illustrated) by a store staff (for example, the facility staff U21 or the like) of the commercial facility 41. Then, the reception unit 561 displays the received payment target information on the touch panel 550.

The payment control unit 562 reads code information of the privilege information displayed on the user terminal 100 from the image captured by the camera 540, analyzes the image, and extracts the privilege ID. Then, the payment control unit 562 controls the camera 540, images the face of the person who makes payment, and acquires the captured face image. Then, the payment control unit 562 transmits a face authentication payment request including the face image, payment target information, the privilege ID, and the terminal information 512 stored in the storage unit 510 to the privilege information issuing apparatus 300. Then, the payment control unit 562 receives a payment completion notification or the like, and displays the payment completion notification or the like on the touch panel 550.

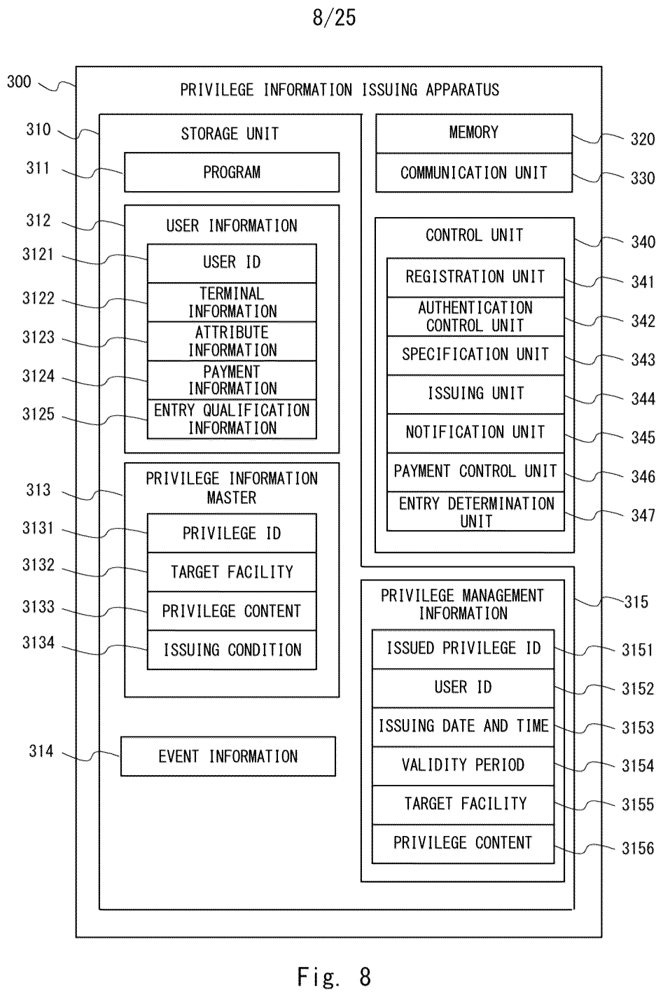

FIG. 8 is a block diagram illustrating a configuration of the privilege information issuing apparatus 300 according to the second example embodiment.

The privilege information issuing apparatus 300 is an example of the aforementioned privilege information issuing apparatus 1. The privilege information issuing apparatus 300 is an information processing apparatus to support sending of customers from the event venue 40 to the commercial facility 41 and the like in the surroundings thereof. The privilege information issuing apparatus 300 may be made redundant across a plurality of serves, and each functional block may be implemented by a plurality of computers.

The privilege information issuing apparatus 300 includes a storage unit 310, a memory 320, a communication unit 330, and a control unit 340. The storage unit 310 is an example of a nonvolatile storage device such as a hard disk or a flash memory. The storage unit 310 stores a program 311, user information 312, a privilege information master 313, event information 314, and privilege management information 315. Note that the storage unit 310 and the face information DB 210 of the authentication apparatus 200 may be collectively regarded as a storage unit. The program 311 is a computer program (privilege information issuing program) in which processing of registering the privilege information, the user information, and the entry qualification information, the privilege information issuing processing, the payment processing including the privilege information utilization processing, and the like according to the second example embodiment are implemented.

The user information 312 is information for managing users in the area 4. Note that “users in area 4” are, for example, purchasers of the entry qualification information of the event venue 40, entry scheduled persons who are scheduled to enter the event venue 40, entering persons, and persons exiting the event venue 40. The user information 312 is information in which a user ID 3121, terminal information 3122, attribute information 3123, payment information 3124, and entry qualification information 3125 are associated.

The user ID 3121 is identification information of the user. The user ID 3121 is information that is the same as or uniquely corresponds to the user ID 211 managed in association with the face feature information 212 in the face information DB 210 of the authentication apparatus 200. Therefore, it is possible to state that the user information 312 is information associated with the identity authentication information for registration of the user via the user ID 3121. The terminal information 3122 is information corresponding to the terminal information 112 of the user terminal 100 described above.

Examples of the attribute information 3123 include, but are not limited to, a name, a date of birth, a sex, an address, a contact (a telephone number, an e-mail address, account information of a social networking service (SNS)), a member rank, information indicating a hobby, preference, or interest, a support target of an athlete or a team, and the like. Note that the member rank may be, for example, information indicating a rank or the like in members who have made payment in the event venue 40, a rank in another member service, or the like.

The payment information 3124 is credit card information, electronic money, barcode payment account information, bank withdrawal account information, or the like, and is also information used for payment using face authentication (face authentication payment).

The entry qualification information 3125 is paid digital entry ticket information for a predetermined event held in the event venue 40 on a date and time of the event. The entry qualification information 3125 may include, for example, an event ID, seat information (a seat position and a seat grade), a ticket price, and the like. Furthermore, the entry qualification information 3125 may include identification information of the event venue, an entry time zone, an event content, and the like, instead of the event ID. Also, it is possible to state that the entry qualification information 3125 according to the present example embodiment is proof information indicating that the user has the qualification of permission to enter the event venue 40 on the basis of success in the face authentication.

The privilege information master 313 is information for managing master information of the privilege information input by facility staff or the area staff. The privilege information master 313 is information in which a privilege ID 3131, a target facility 3132, a privilege content 3133, and an issuing condition 3134 are associated. The privilege ID 3131 is identification information of privilege information. The target facility 3132 is information indicating a facility where the privilege information can be used. The target facility 3132 is, for example, information indicating any of the commercial facilities 41 to 4n and the nearest station 610. Note that the target facility 3132 may target at two or more facilities. For example, the target facility 3132 may be a target of two or more facilities among the commercial facilities 41 to 4n.

The privilege content 3133 is information indicating a product or a service that the user can enjoy by being used in the facility. Examples of the privilege content 3133 include, but are not limited to, discount information indicating a discount price or a discount rate, a discount target product or service, a free product or service, and the like.

The issuing condition 3134 is information indicating a condition for issuing the privilege information. Examples of the issuing condition 3134 include event information (an event ID, date and time, and the like) to be issued, the fact that entry qualification information of the event information has already been purchased, and an issuing timing. The issuing timing is an issuing start date and time, a period during which issuing can be performed, a timing that is attributable to an end time of the target event, or the like. The timing that is attributable to the end time of the target event is, for example, a timing at which the target event ends, a timing after the start of the target event and a predetermined time (second time) before the scheduled end time, a timing within a predetermined time after the end of the target event, or the like. In addition, examples of the issuing condition 3134 include, but are not limited to, attribute information of the user as a target of issuing, a seat grade, a ticket price, a priority order of attribute information prioritizing issuance, and the like.

The event information 314 is information defining an event held at the event venue 40. The event information 314 includes, for example, an event ID, a venue, event hour information, event contents, seat information (a seat type, a seat number, and arrangement), a price of the entry qualification information (ticket price), and the like. Note that examples of the event hour information include, but are not limited to, an event period, a start date and time, a scheduled start time, a scheduled end time, an entry time zone, an entry start time, and the like.

The privilege management information 315 is information for managing the privilege information issued for the user. The privilege management information 315 is information in which an issued privilege ID 3151, a user ID 3152, an issuing date and time 3153, a validity period 3154, a target facility 3155, and privilege content 3156 are associated.

The issued privilege ID 3151 is the privilege ID 3131 issued for the user corresponding to the user ID 3152. The user ID 3152 is the user ID 3121 for which the privilege information has been issued. Therefore, the privilege management information 315 is, for example, information uniquely specified by a set of the issued privilege ID 3151 and the user ID 3152. The issuing date and time 3153 is a date and time on which the privilege information has been issued. The validity period 3154 is a period in which the privilege according to the privilege information can be enjoyed (the privilege information is valid). The validity period 3154 is defined by a start date and time and an end date and time (effective period). In a case where the corresponding privilege information can be used immediately after the issuing, a date and time of the effective period may be set as the validity period 3154. The target facility 3155 is a facility where the privilege information can be used, and is the target facility 3132 associated with the privilege ID 3131 corresponding to the issued privilege ID 3151. In principle, the privilege content 3156 is the privilege content 3133 associated with the privilege ID3131 corresponding to the issued privilege ID 3151.

The memory 320 is a volatile storage device such as a RAM, and is a storage region for temporarily holding information during the operations of the control unit 340. The communication unit 330 is a communication interface with the network N.

The control unit 340 is a processor, that is, a control apparatus that controls each configuration of the privilege information issuing apparatus 300. The control unit 340 reads the program 311 from the storage unit 310 into the memory 320 and executes the program 311. Therefore, the control unit 340 implements functions of a registration unit 341, an authentication control unit 342, a specification unit 343, an issuing unit 344, a notification unit 345, an entry determination unit 346, and a payment control unit 347. Note that the authentication control unit 342, the specification unit 343, and the issuing unit 344 are examples of the issuing unit 11 described above. In addition, the specification unit 343 and the notification unit 345 are examples of the notification unit 12 described above.

The registration unit 341 performs registration processing and the like of the privilege information, the user information, and the entry qualification information. Specifically, the registration unit 341 receives a registration request of individual privilege information from the management terminal 61 or the like and registers the privilege information in the privilege information master 313. At this time, the registration unit 341 issues a privilege ID for the new privilege information. Furthermore, the registration unit 341 receives a registration request of the user information from the user terminal 100 or the like, and registers the registration request in the user information 312. At this time, the registration unit 341 registers face feature information based on a face image for a new user in the authentication apparatus 200, and acquires a user ID issued at the time of the registration. Then, the registration unit 341 registers the acquired user ID 3121 and the information included in the registration request in an associated manner as the user information 312 in the storage unit 310. The registration unit 341 registers, in the storage unit 310, identity authentication information for registration of the user and terminal information possessed by the user in association with each other. The registration unit 341 according to the present example embodiment registers, in the storage unit 310, the user ID 3121 uniquely corresponding to the face feature information for registration of the user, the terminal information 3122, the attribute information 3123, and the payment information 3124 as the user information 312. Furthermore, the registration unit 341 receives a registration request including the face image and the entry qualification information, associates the entry qualification information 3125 with the user information 312 specified by the face authentication based on the face image, and updates the user information 312.

The authentication control unit 342 controls identity authentication of the user using the authentication apparatus 200. In particular, the authentication control unit 342 according to the present example embodiment controls biometric authentication of the user using biometric information extracted from an image obtained by imaging the user. Specifically, the authentication control unit 342 controls the face authentication of the user using the face feature information extracted from the face image of the user. In other words, in a case where the authentication control unit 342 receives the identity authentication information for authentication of the user and the entry qualification information, the authentication control unit controls the identity authentication with reference to the storage unit 310 and the face information DB 210 of the authentication apparatus 200 using the identity authentication information for authentication. In addition, in a case where the authentication control unit 342 receives a privilege issuing request including the face image or a privilege information inquiry request from the user terminal 100, the authentication control unit 342 transmits a face authentication request including the face image included in the request to the authentication apparatus 200 and receives a face authentication result from the authentication apparatus 200. Then, the authentication control unit 342 outputs the face authentication result to the specification unit 343 and the issuing unit 344. Also, in a case where the authentication control unit 342 receives an entry determination request from the entry control terminal 401, the authentication control unit 342 transmits a face authentication request including the face image included in the entry determination request to the authentication apparatus 200, receives a face authentication result from the authentication apparatus 200, and outputs the face authentication result to the entry determination unit 346. Also, in a case where the authentication control unit 342 receives a face authentication payment request from the payment terminal 51 or the like, the authentication control unit 342 transmits a face authentication request including the face image included in the face authentication payment request to the authentication apparatus 200, receives a face authentication result from the authentication apparatus 200, and outputs the face authentication result to the payment control unit 347. Note that the authentication control unit 342 may control the identity authentication other than the biometric authentication.

The specification unit 343 specifies the terminal information, the attribute information, the payment information, the entry qualification information, and the privilege information of the user on the basis of the identity authentication for the user. Specifically, in a case where the face authentication by the authentication control unit 342 is successful, the specification unit 343 specifies the terminal information 3122, the attribute information 3123, the payment information 3124, and the entry qualification information 3125 associated with the user ID 3121 of the user who has succeeded in the face authentication from the user information 312. In addition, the specification unit 343 specifies a list of privilege information associated with the user ID 3152 of the user who has succeeded in the face authentication from the privilege management information 315 in response to a privilege information inquiry request. Furthermore, the specification unit 343 specifies the issued privilege ID 3151 included in the face authentication payment request, and specifies the privilege information associated with the user ID 3152 of the user who has succeeded in the face authentication and the issued privilege ID 3151 from the privilege management information 315.

Furthermore, the specification unit 343 specifies the user who is the issuing target of the privilege information at the timing that is attributable to the end time of the event. In addition, the specification unit 343 specifies attribute information of the user who is the issuing target. Also, the specification unit 343 may determine the validity period, the privilege content, and the target facility of the privilege information as a target of issuing on the basis of the specified attribute information. Note that the specification unit 343 may determine the validity period (at least an effective period) in accordance with the type of the event that has ended, the scheduled end time, and the end time irrespective of the attribute information.

The issuing unit 344 issues the privilege information for the users U1 who have entry qualification information registered and have entered the event venue 40 through face authentication. At this time, a validity period based on the end time of the event corresponding to the entry qualification information has been set in the privilege information. In particular, the issuing unit 344 issues the privilege information in which a first time after the end time of the event corresponding to the entry qualification information has been set as an effective period. Here, examples of the “first time” include, but are not limited to, a fixed time such as three hours and dynamically determining a time (validity period) with the time of the effective period fixed.

Also, the issuing unit 344 issues the privilege information in accordance with the attribute information associated with the user U1. For example, the issuing unit 344 issues the privilege information in which the validity period, the privilege content, and the target facility determined on the basis of the attribute information have been set. In addition, the issuing unit 344 issues the privilege information that grants the privilege content in accordance with the attribute information. In addition, the issuing unit 344 may issue the privilege information that can be used in different facilities in accordance with the attribute information from among the facilities in the neighborhood. For example, the issuing unit 344 may issue a coupon for a facility “cafe” if the attribute information indicates a female, and may issue a coupon of for a facility “ramen shop” if the attribute information indicates a male. It is thus possible to use the facilities in a dispersed manner and to alleviate congestion in the facilities.

Moreover, the issuing unit 344 may select and issue privilege information that satisfy an issuing condition 3134 on the basis of attribute information 3123 and entry qualification information 3125 associated in advance with the user U1 from a privilege information master 313.

The notification unit 345 notifies the user terminals 100 of the users U1 who have entered the event venue 40 through face authentication of the privilege information issued by the issuing unit 344 at the timing that is attributable to the end time. For example, the notification unit 345 issues the privilege information at the time of the end of the event. The notification unit 345 regards the terminal information 3122 associated with the entry qualification information 3125 of the event that has ended as destinations and provides notifications to the user terminals 100.

Moreover, the specification unit 343 and the issuing unit 344 select users who are issuing targets of the privilege information in accordance with the attribute information associated with each of the plurality of users who have entered the event venue through the identity authentication and issues the privilege information for the selected users. Then, the notification unit 345 notifies the terminals of the selected users of the issued privilege information. Note that in a case where a face authentication result output from the authentication control unit 342 indicates that the face authentication has been successful, the specification unit 343 or the issuing unit 344 performs issuing or collating of the privilege information in response to a request.

The entry determination unit 346 determines whether or not the face authentication result based on the entry determination request received from the entry control terminal 401 indicates that the face authentication has been successful, and transmits the entry determination result to the entry control terminal 401. In a case where the user is a user who has succeeded in the face authentication and has registered entry qualification information, the entry determination unit 346 includes permission of entry in the entry determination result. On the other hand, in a case where the face authentication has been failed, or in a case where the user does not have a registered entry qualification information although the face authentication has been successful, the entry determination unit 346 includes non-permission of entry in the entry determination result. Note that, in a case where the face authentication has been successful, the entry determination unit 346 may perform registration in the user information 312 such that completion of entry of the user who has succeeded in the face authentication can be identified. For example, the entry determination unit 346 may register an entry state flag indicating “completion of entry” or the date and time of entry in the entry qualification information 3125 associated with the user ID 3121 of the user who has succeeded in the face authentication. Note that the entry determination unit 346 may update the entry state flag to “completion of exiting” in a case where exiting of the user is detected through face authentication or the like.

The payment control unit 347 determines whether or not a face authentication result based on a face authentication payment request received from the payment terminal 51 or the like has been successful, and in a case where the face authentication has been successful, the payment control unit 347 specifies the user ID of the user who has succeeded in the face authentication and controls the payment processing. In particular, in a case where the privilege ID is included in the face authentication payment request, the payment control unit 347 determines whether or not the privilege information corresponding to the privilege ID can be used, and in a case where the privilege information can be used, the payment control unit 347 performs payment processing using the privilege information. Specifically, the payment control unit 347 specifies the facility from the terminal information included in the received face authentication payment request and specifies the target facility 3155 associated with the privilege ID (the issued privilege ID 3151) included in the face authentication payment request. In a case where the specified facility is included in the target facility 3155, the payment control unit 347 determines that the privilege information can be used. Furthermore, in a case where the utilization state flag and the like are included in the privilege management information 315, the payment control unit 347 may determine the availability in consideration of the utilization state flag and the like.

Then, in a case where the privilege information can be used, the payment control unit 347 specifies the payment information 3124 associated with the specified user ID 3121 from the user information 312. Then, the payment control unit 347 specifies the privilege content 3156 associated with a set of the issued privilege ID 3151 and the specified user ID 3152 from the privilege management information 315. Then, the payment control unit 347 applies the specified privilege content 3156 to the price of the payment target information included in the face authentication payment request and calculates a payment price. In a case where the privilege content 3156 is “everything 5% off”, for example, the payment control unit 347 calculates a price obtained by subtracting 5% from the price of the payment target information as the payment price. Then, the payment control unit 347 transmits an instruction for withdrawing the payment price to a payment server (not illustrated) using the specified payment information 3124 and receives a payment result. Note that the payment server is a known server operated by a financial institution or the like and illustration and detailed description thereof will thus be omitted. Also, in a case where the privilege content 3156 is “one glass of beer for free (upon ordering a snack set)”, and the snack set and the beer are included in the payment target information, the payment control unit 347 subtracts the price of one glass of beer from the price of the payment target information and calculates the payment price.

On the other hand, in a case where the privilege information cannot be used, the payment control unit 347 performs the payment processing without using the privilege information. In other words, the payment control unit 347 performs the payment processing for the payment target information using the payment information of the specified user ID.

Here, a flow of registration of the privilege information will be described. Here, an example in which the facility staff U21 registers privilege information of the commercial facility 41 will be described. First, the management terminal 61 receives inputs of privilege content that can be used in the commercial facility 41, an issuing condition, and a target facility from the facility staff U21. The issuing conditions include event information that is a target of issuing. The target facility is the commercial facility 41. Then, the management terminal 61 transmits a privilege information master registration request including the received privilege content, issuing condition, and target facility to the privilege information issuing apparatus 300 via the network N. In response to the request, the privilege information issuing apparatus 300 issues the privilege ID corresponding to the privilege content included in the received privilege information master registration request and registers the issued privilege ID 3131, the target facility 3132 included in the request, the privilege content 3133, and the issuing condition 3134 in an associated manner as the privilege information master 313 in the storage unit 310. Similarly, a facility staff U2n and a facility staff of the public transportation register privilege information related to their own facilities. Note that an area staff U3 may register the privilege information of the commercial facility 41 and the like and the nearest station 610 using the management terminal 600. In addition, the facility staff U21 to U2n, the area staff U3, and the like may update the privilege content, the issuing conditions, and the target facilities in the privilege information that has already been registered.

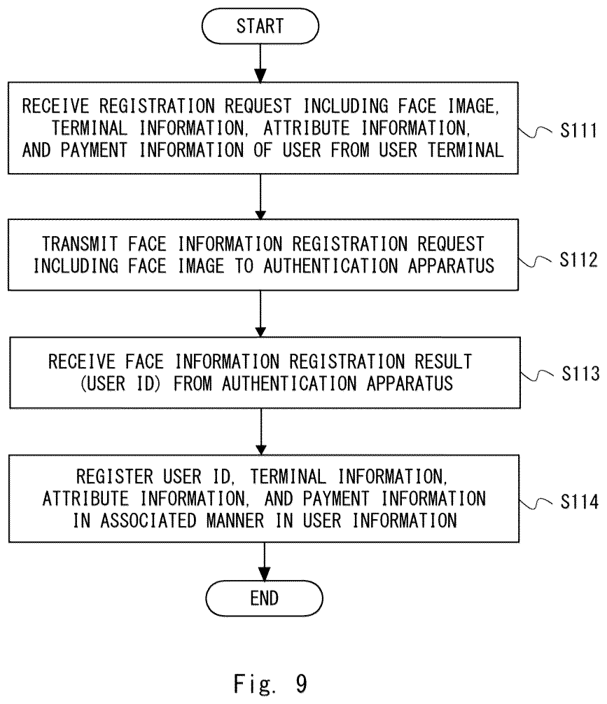

FIG. 9 is a flowchart illustrating a flow of member information registration processing according to the second example embodiment. First, the privilege information issuing apparatus 300 receives a registration request including a face image, terminal information, attribute information, and payment information of the user U1 from the user terminal 100 via the network N (S111). Then, the privilege information issuing apparatus 300 transmits a face information registration request including the face image to the authentication apparatus 200 via the network N (S112). In response to the transmission, the authentication apparatus 200 performs face information registration processing.

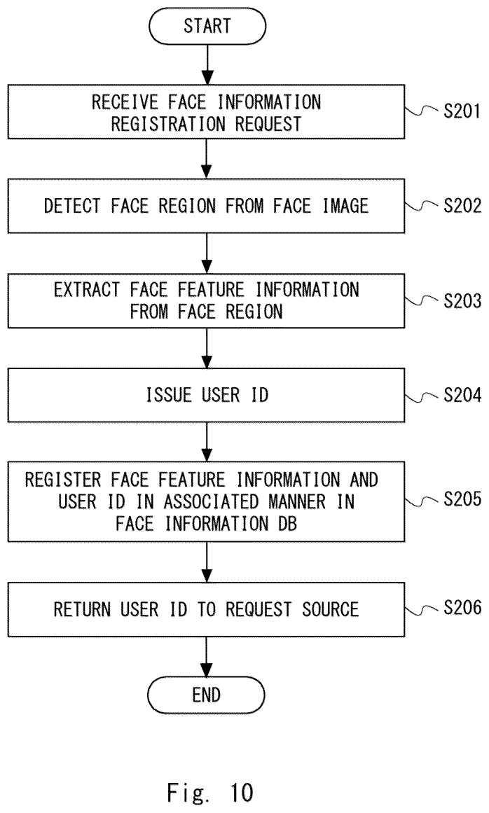

FIG. 10 is a flowchart illustrating a flow of face information registration processing performed by the authentication apparatus according to the second example embodiment. First, the authentication apparatus 200 receives the face information registration request (S201). For example, the authentication apparatus 200 receives the face information registration request from the privilege information issuing apparatus 300 via the network N. Then, the face detection unit 220 detects a face region from the face image included in the face information registration request (S202). Then, the feature point extraction unit 230 extracts feature points (face feature information) from the face region detected in Step S202 (S203). Then, the registration unit 240 issues the user ID 211 (S204). Then, the registration unit 240 registers the extracted face feature information 212 and the issued user ID 211 in an associated manner in the face information DB 210 (S205). Thereafter, the registration unit 240 returns the issued user ID 211 to the request source (for example, the privilege information issuing apparatus 300) (S206). Note that the authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 9, the description will be continued.

The privilege information issuing apparatus 300 receives a face information registration result (user ID) from the authentication apparatus 200 via the network N (S113). Then, the privilege information issuing apparatus 300 registers the received user ID 3121 and the terminal information 3122, the attribute information 3123, and the payment information 3124 received in Step S101 in an associated manner in the user information 312 (S114).

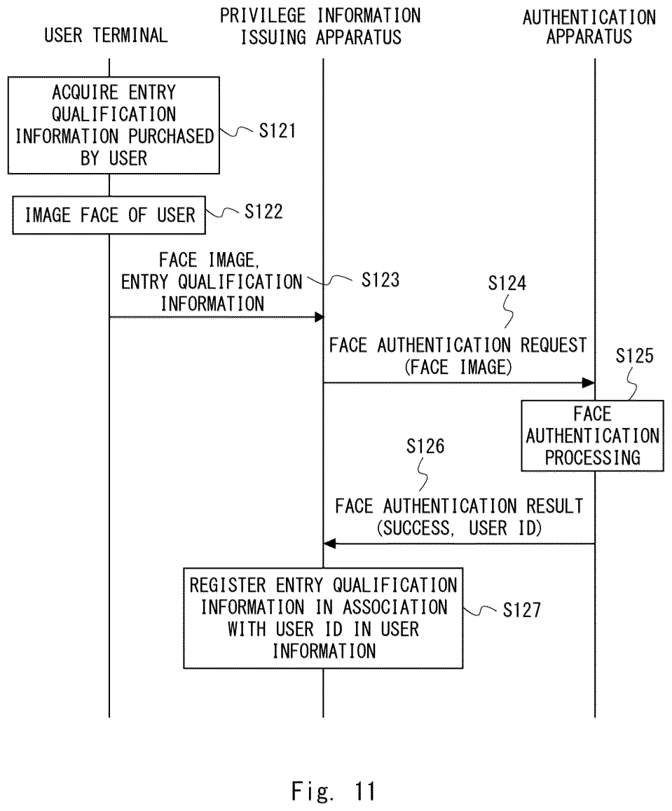

FIG. 11 is a sequence diagram illustrating a flow of entry qualification information registration processing according to the second example embodiment. As a premise, it is assumed that the user U1 has registered the user information in the privilege information issuing apparatus 300 and has purchased entry qualification information of an event held on a predetermined date at the event venue 40. At this time, the user terminal 100 acquires the entry qualification information purchased by the user U1 (S121). For example, the user terminal 100 may receive an input of identification information or the like of the entry qualification information from the user U1. Alternatively, the user terminal 100 may acquire information regarding the entry qualification information provided through a notification from a purchasing site of the entry qualification information. Then, the user terminal 100 images the face of the user U1 (S122). Then, the user terminal 100 transmits a registration request including the face image and the entry qualification information to the privilege information issuing apparatus 300 via the network N (S123).

Then, the privilege information issuing apparatus 300 transmits a face authentication request including the received face image to the authentication apparatus 200 via the network N (S124). In response to the transmission, the authentication apparatus 200 performs face authentication processing (S125).

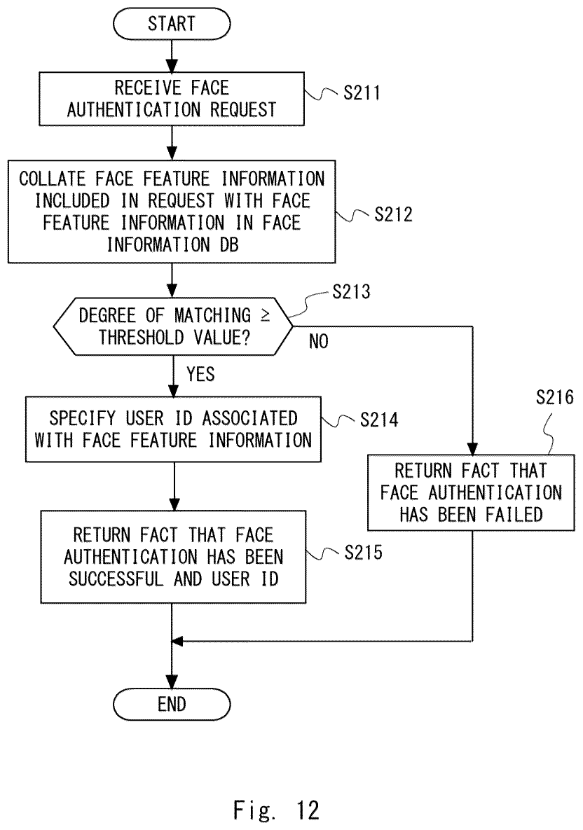

FIG. 12 is a flowchart illustrating a flow of face authentication processing performed by the authentication apparatus according to the second example embodiment. First, the authentication apparatus 200 receives a face authentication request from the privilege information issuing apparatus 300 via the network N (S211). Then, the authentication apparatus 200 extracts face feature information from the face image included in the face authentication request similarly to Steps S202 and S203 described above. Then, the authentication unit 250 of the authentication apparatus 200 collates the face feature information extracted from the face image included in the face authentication request with the face feature information 212 of the face information DB 210 (S212), and calculates a degree of matching. Then, the authentication unit 250 determines whether or not the degree of matching is equal to or greater than a threshold value (S213). In a case where the pieces of face feature information match each other, that is, in a case where the degree of matching between the pieces of face feature information is equal to or greater than the threshold value, the authentication unit 250 specifies the user ID 211 associated with the face feature information 212 (S214). Then, the authentication unit 250 returns a face authentication result, which includes information indicating that the face authentication has been successful and the specified user ID 211, to the privilege information issuing apparatus 300 via the network N (S215). In a case where the degree of matching is less than the threshold value in Step S213, the authentication unit 250 returns the face authentication result including information indicating that the face authentication has been failed to the privilege information issuing apparatus 300 via the network N (S216).

Returning to FIG. 11, the description will be continued.

The privilege information issuing apparatus 300 receives the face authentication result from the authentication apparatus 200 via the network N (S126). Then, the privilege information issuing apparatus 300 determines whether or not the face authentication has been successful. Specifically, the privilege information issuing apparatus 300 refers to the face authentication result and determines that the face authentication has been successful if the face authentication result includes the user ID. Note that in a case where it is determined that the face authentication has been failed, the privilege information issuing apparatus 300 may return the fact that the user has failed the face authentication to the user terminal 100 via the network N.

In a case where the face authentication has been successful, the privilege information issuing apparatus 300 associates the entry qualification information 3125 received in Step S123 with the user ID 3121 included in the face authentication result and registers them in the user information 312 (S127).

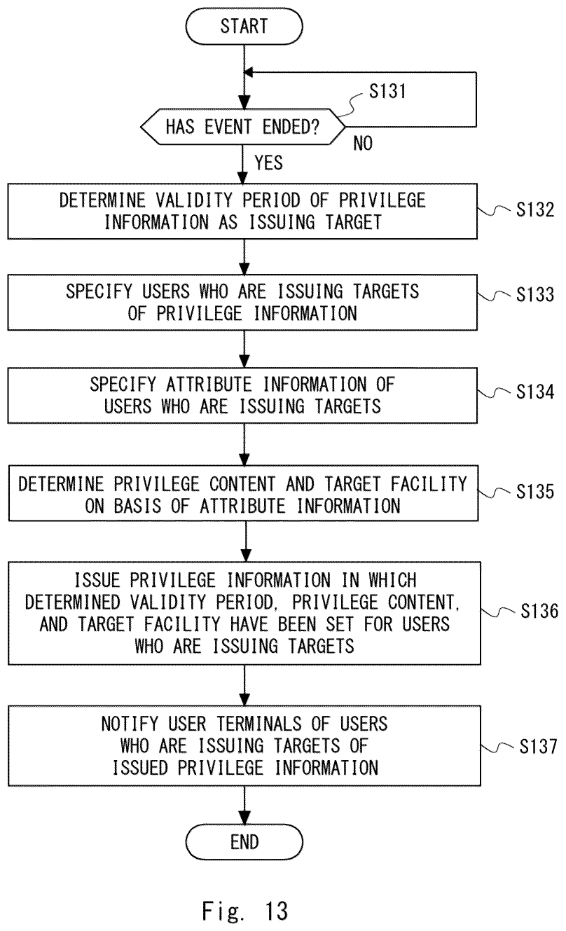

FIG. 13 is a flowchart illustrating a flow of privilege information issuing processing according to the second example embodiment. As a premise, it is assumed that the users U1-1 to U1-m who have purchased the entry qualification information corresponding to a predetermined event have succeeded in face authentication performed by the entry control terminal 401 and have already been entered the event venue 40. Also, it is assumed that the event has started in an event hall 402 in the event venue 40. Note that in addition to the user U1, there may be users U4 who have entered the event venue 40 without face authentication.

Then, the privilege information issuing apparatus 300 determines whether or not the event has ended (S131). For example, the privilege information issuing apparatus 300 determines that the event has ended in a case where an event end notification has been received from a management terminal (not illustrated) or a management server (not illustrated) of an event organizer. Alternatively, the privilege information issuing apparatus 300 transmits an end confirmation request designating an event ID to the management server and determines that the event has ended in a case where an event end notification has been received from the management server. Note that in a case where it is determined that the event has not ended, the privilege information issuing apparatus 300 waits for a predetermined time and then executes Step S131 again.

In a case where it is determined that the event has ended, the privilege information issuing apparatus 300 determines a validity period of privilege information that is a target of issuing (S132). For example, it is only necessary for the privilege information issuing apparatus 300 to determine the validity period by regarding the current time as a start time and a time which is a preset first time (3 hours, for example) after the start time as an end time (effective period). Alternatively, the privilege information issuing apparatus 300 may dynamically calculate the first time with the effective period fixed and determine the validity period. For example, the clock time of the last train on the day of the event or 10:00 am on the next day of the event may be set as the effective period. Then, the privilege information issuing apparatus 300 may calculate the time from the event end time to the effective period as the first time and determine the event end time to the effective period as the validity period. Alternatively, the privilege information issuing apparatus 300 may refer to the event information 314 corresponding to the event ID included in the event end notification and determine the validity period in accordance with the type of the event that has ended. Alternatively, the privilege information issuing apparatus 300 may determine an availability condition instead of the validity period. As the availability condition of the privilege information, first several persons may be able to use the privilege information, for example. It is possible to enhance a motivation of the user to go to a commercial facility in the surroundings as soon as possible by setting the first-come first-served rule as the availability condition of the privilege information. Therefore, the users are more likely to drop by at the commercial facilities in the surroundings from the event venue. Also, it is possible to promote cooperative utilization of the event venue and the commercial facilities in the surroundings thereof.

Then, the privilege information issuing apparatus 300 specifies the user who is an issuing target of the privilege information (S133). Here, the privilege information issuing apparatus 300 specifies the user who has the entry qualification information 3125 corresponding to the event ID included in the event end notification and has the user ID 3121 that indicates that the user has actually entered the event venue as the user who is the issuing target. For example, the users for whom an entry state flag indicating that “already entered” has been registered as described above may be regarded as the users who are the issuing target. Note that in a case where a plurality of users who are issuing targets are specified, the privilege information issuing apparatus 300 executes subsequent Steps S134 to S137 for each of the users who are the issuing targets.

Then, the privilege information issuing apparatus 300 specifies attribute information of the user who is the issuing target (S134). Specifically, the privilege information issuing apparatus 300 specifies attribute information 3123 associated with the user ID 3121 of the user who is the issuing target and has been specified in Step S133 from the user information 312.

Then, the privilege information issuing apparatus 300 specifies privilege content and a target facility on the basis of the specified attribute information (S135). Specifically, it is only necessary for the privilege information issuing apparatus 300 to specify a set of a privilege ID 3131, a target facility 3132, and privilege content 3133, the specified attribute information and related information thereof are defined in the issuing condition 3134, from the privilege information master 313. For example, the privilege information issuing apparatus 300 may select privilege information with a degree of matching of a generation, a sex, a member rank, a hobby, a preference, an interest, and the like of the user indicated by the attribute information with the content defined in the issuing condition of equal to or greater than a threshold value from a plurality of pieces of privilege information. Furthermore, the privilege information issuing apparatus 300 may appropriately change the target facility 3132 and the privilege content 3133 in the selected privilege information in consideration of the member rank and the like. Note that the privilege information issuing apparatus 300 may determine the privilege content and the target facility in accordance with a seat grade and a ticket price from the entry qualification information 3125 that the user as the target of issuing has purchased and the event ID. Note that the seat grade and the ticket price may be regarded as attribute information of the user as the target of issuing.

Then, the privilege information issuing apparatus 300 issues privilege information for which the validity period determined in Step S132 and the privilege content and the target facility determined in Step S134 have been set for the user who is the issuing target (S136). Specifically, the privilege information issuing apparatus 300 associates the privilege ID of the selected privilege information, the determined target facility, and the determined privilege content as an issued privilege ID 3151, a target facility 3155, and privilege content 3156 and generates the privilege management information 315. In addition, the privilege information issuing apparatus 300 sets the issuing target user in the user ID 3152, the current date and time in the issuing date and time 3153, and the determined validity period in the validity period 3154 in the generated privilege management information 315. The privilege information issuing apparatus 300 registers the generated and set privilege management information 315 in the storage unit 310.

Thereafter, the privilege information issuing apparatus 300 notifies the user terminals 100 of the users U1 who are issuing targets (with the terminal information 3122 designated as destinations) of the issued privilege information (S137). In response to the notification, the user terminal 100 displays the privilege information provided through the notification.

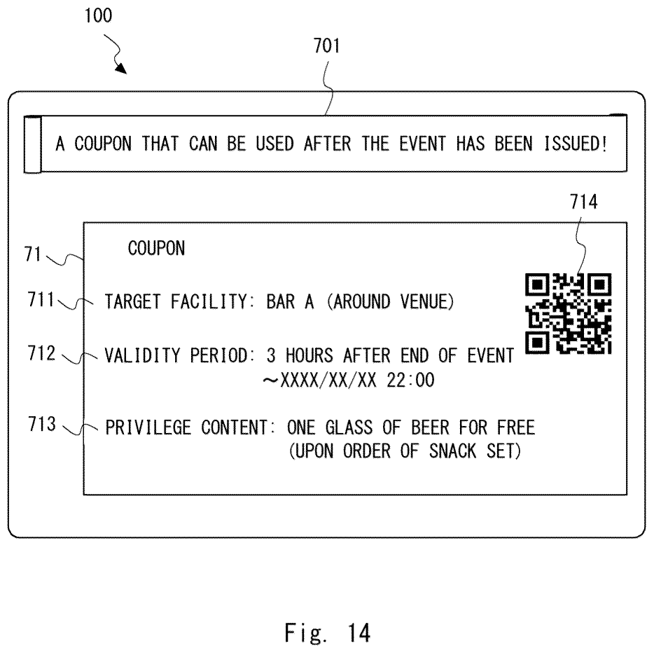

FIG. 14 is a diagram illustrating a display example of privilege information according to the second example embodiment. A notification message 701 is text information included in the privilege information provided through the notification. Here, although the notification message 701 indicates “a coupon that can be used after the event has been issued!”, the notification message 701 is not limited thereto. A coupon 71 displays a target facility 711, a validity period 712, privilege content 713, and code information 714. The target facility 711 indicates a bar A (the commercial facility 41, for example) around the event venue 40, and the validity period 712 indicates three hours after the end of the event. The privilege content 713 indicates that a glass of beer will be provided for free (upon an order of a snack set). The code information 714 is a two-dimensional code including the privilege ID. Note that the target facility 711, the validity period 712, the privilege content 713, and the code information 714 are examples and are not limited thereto.

In this manner, the users U1 can recognize that the coupon 71 can be used in the bar A before elapse of 3 hours after the event and are motivated to go to the bar A on the way to the nearest station 610 after leaving the event venue 40, for example. Then, the users U1 can select and display the coupon 71 using the user terminals 100 and use the coupon 71 in the bar A. At this time, the payment terminal 51 images code information of the code information 714 with the camera 540, analyzes the captured image, extracts the image as a privilege ID, and images the face of the user U1. Then, the payment terminal 51 transmits a face authentication payment request including the face image, the payment target information, the privilege ID, and the terminal information 512 to the privilege information issuing apparatus 300 via the network N. Then, the authentication control unit 342 and the payment control unit 347 of the privilege information issuing apparatus 300 performs the payment processing using the face authentication of the user U1 and the privilege information as described above. In this manner, the commercial facility 41 can get profit due to the end of the event. Also, the timings at which the users go to the nearest station 610 are dispersed, and congestion at the transportation facilities is likely to be alleviated, by a certain number of users who use the privilege information issued in response to the end of the event being present. Therefore, it is possible to revitalize the region by sending customers from the event venue to the commercial facilities in the surroundings. Therefore, it is possible to promote cooperative utilization of the event venue and the commercial facilities around the event venue.

### Third Example Embodiment

A third example embodiment is a more specific example of the second example embodiment described above. An issuing unit according to the third example embodiment specifies a travel direction of each of a plurality of users after the event on the basis of attribute information and estimates, for each travel direction, a degree of congestion of at least one of a road or a transportation facility around an event venue on the basis of the number of users in the specified travel direction. Then, the issuing unit selects users of the travel direction in which the estimated degree of congestion is equal to or greater than a predetermined value as issuing targets of privilege information from among the plurality of users. In particular, it is only necessary for the issuing unit to further consider operation information for each direction of the nearest transportation facility to the event venue and to estimate the degree of congestion at the transportation facility. Note that an overall configuration and an individual configuration of the privilege information issuing system 1000 according to the third example embodiment are similar to those of the second example embodiment described above, and repeated description and illustration will thus be omitted. However, it is assumed that the public transportation that runs the nearest station 610 operates a management server that manages a traveling state of each line and the privilege information issuing apparatus 300 can acquire the operation information indicating the traveling state from the management server in the third example embodiment.

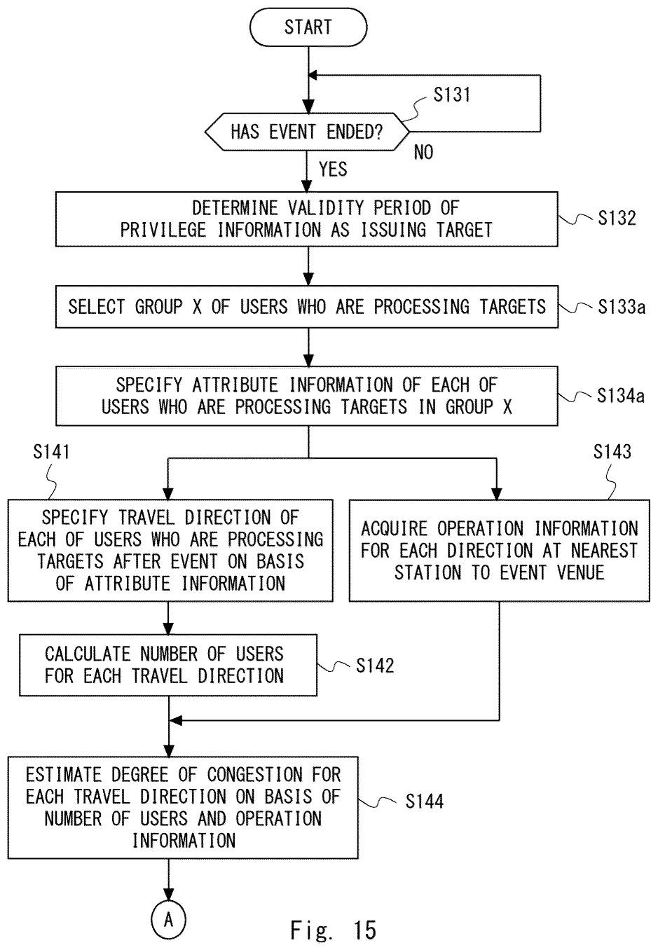

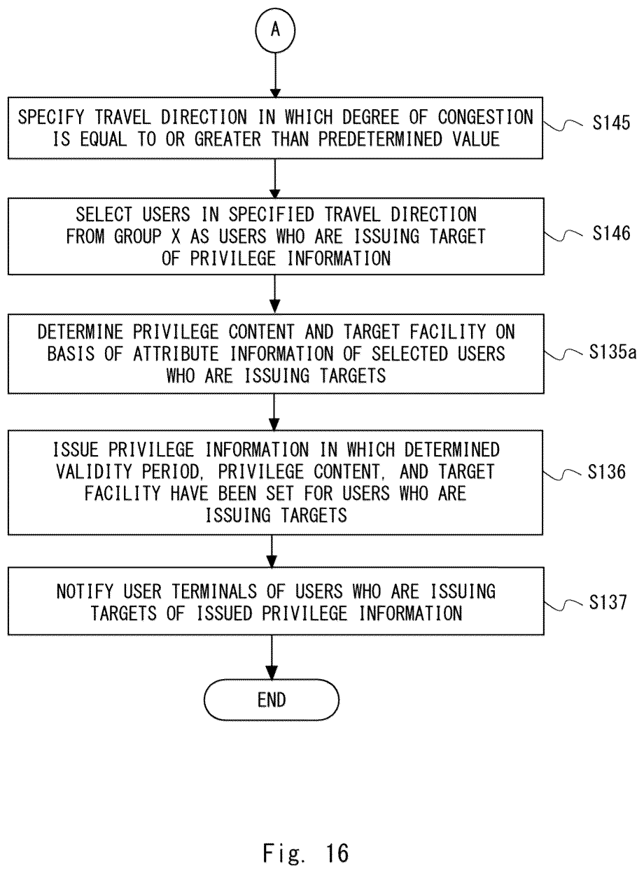

FIGS. 15 and 16 are flowcharts illustrating a flow of privilege information issuing processing according to the third example embodiment. Then, the privilege information issuing apparatus 300 executes Steps S131 and S132 similarly to FIG. 13 described above. Next, the privilege information issuing apparatus 300 selects a group X of users who are processing target (S133a). Specifically, the privilege information issuing apparatus 300 refers to the user information 312, selects users ID of the users who have the entry qualification information and have actually entered the event venue (before exiting the event venue) similarly to Step S133 described above, and regards a list of the selected user IDs as the group X. Then, the privilege information issuing apparatus 300 specifies attribute information of each of the users who are the processing targets in the group X similarly to Step S134 described above (S134a).

Thereafter, the privilege information issuing apparatus 300 specifies the travel direction of each of the users who are the processing targets after the event on the basis of the attribute information (S141). Specifically, the privilege information issuing apparatus 300 specifies the travel direction of each user who is the target of processing after the event from an address or the like included in the specified attribute information and the nearest station 610 to the event venue 40. Then, the privilege information issuing apparatus 300 calculates the number of users for each travel direction (S142).

Moreover, the privilege information issuing apparatus 300 acquires operation information for each direction at the nearest station 610 to the event venue 40 after Step S134a (S143). Specifically, the privilege information issuing apparatus 300 acquires operation information related to the line at the nearest station 610 from the aforementioned management server of the public transportation. The operation information includes, for example, directions of each line, schedules, boarding rates, delay situations due to accidents, and the like.

After Steps S142 and S143, the privilege information issuing apparatus 300 estimates a degree of congestion for each travel direction on the basis of the number of users and the operation information (S144). For example, the privilege information issuing apparatus 300 estimates the degree of congestion in each of directions D1 and D2. Note that a known technology may be used for the processing of estimating the degree of congestion.

Then, the privilege information issuing apparatus 300 specifies the travel direction in which the degree of congestion is equal to or greater than a predetermined value (S145). Then, the privilege information issuing apparatus 300 selects users of the travel direction specified in Step S145 from the group X as users who are issuing targets of the privilege information (S146). In a case where the degree of congestion in the direction D1 (out-bound line) is equal to or greater than the predetermined value, and the degree of congestion in the direction D2 (in-bound line) is less than the predetermined value, for example, the privilege information issuing apparatus 300 selects the users, the travel direction of which after the event has been specified as D1 in Step S141, as the users who are issuing targets. Furthermore, it is assumed that the direction D1 is a direction to Yokohama, the direction D2 is a direction to Saitama, and the number of users returning in the direction to Yokohama has been estimated to be larger than the number of users returning in the direction to Saitama, for example. In this case, the privilege information issuing apparatus 300 selects the users returning in the direction to Yokohama as the users who are issuing targets.

Then, the privilege information issuing apparatus 300 determines privilege content and a target facility similarly to Step S135 described above on the basis of attribute information of the selected users who are issuing targets (S135a). Thereafter, the privilege information issuing apparatus 300 executes Steps S136 and S137 described above. Note that even in a case where the degrees of congestion both in the directions D1 (out-bound line) and D2 (in-bound line) are equal to or greater than the predetermined value, the privilege information issuing apparatus 300 may differently determine the validity periods, privilege content, target facilities, and the like in accordance with a difference between the degrees of congestion.

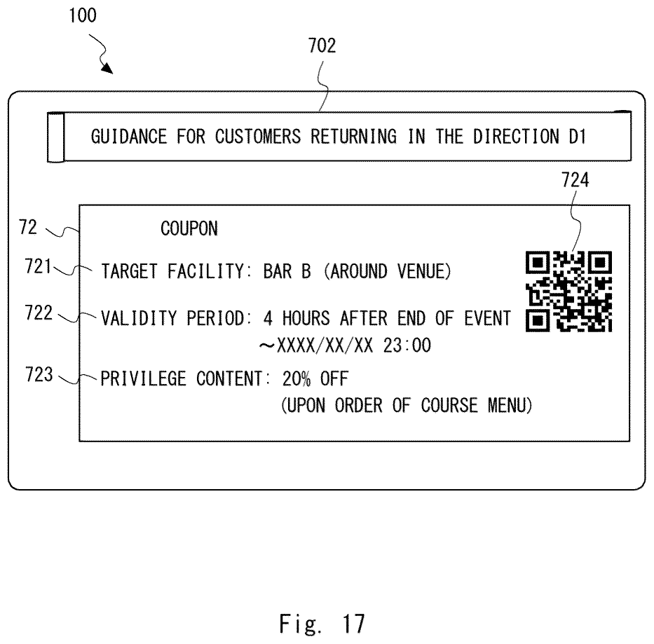

FIG. 17 is a diagram illustrating a display example of privilege information according to the third example embodiment. Although a notification message 702 indicates “guidance for customers returning in the direction D1”, the notification message 702 is not limited thereto. A coupon 72 displays a target facility 721, a validity period 722, privilege content 723, and code information 724. The target facility 721 indicates a bar B (the commercial facility 42, for example) around the event venue 40, and the validity period 722 indicates four hours after the end of the event. The privilege content 723 indicates 20% off (upon order of a course menu).

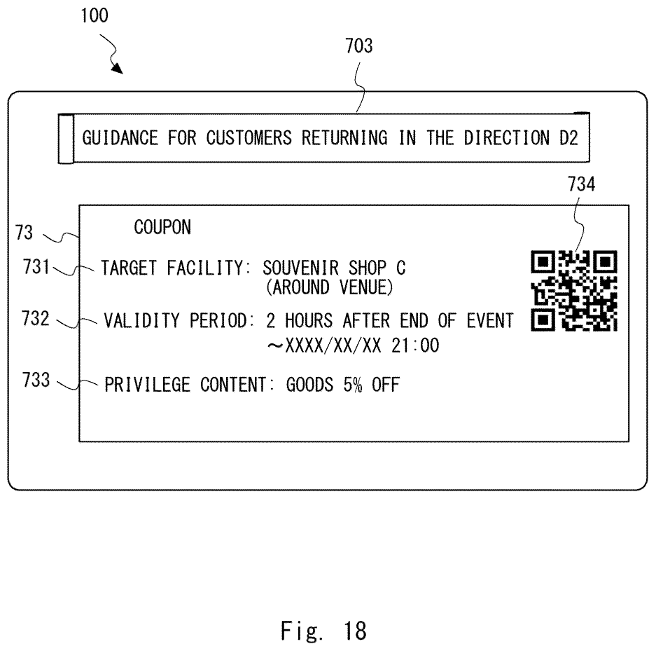

FIG. 18 is a diagram illustrating a display example of privilege information according to the third example embodiment. Although a notification message 703 indicates “guidance for customers returning in the direction D2”, the notification message 703 is not limited thereto. A coupon 73 displays a target facility 731, a validity period 732, privilege content 733, and code information 734. The target facility 731 indicates a souvenir shop C (the commercial facility 43, for example) around the event venue 40, and the validity period 732 indicates two hours after the end of the event. The privilege content 733 indicates goods 5% off.

FIGS. 17 and 18 described above illustrate an example of privilege information in a case where the degree of congestion in the direction D1 (out-bound line) is higher than the degree of congestion in D2 (in-bound line). In other words, a case where the number of users in the travel direction D1 is larger than that in D2 among the users who have entered the event through face authentication is illustrated. Therefore, the coupon 72 is privilege information issued for the users going in the direction D1 after the event, while the coupon 73 is privilege information issued for the users going in the direction D2 after the event. Since further congestion has been estimated in the direction D1 than in the direction D2, the validity period 722 is longer than the validity period 732 by 2 hours (the effective period ends 2 hours later). In addition, the privilege content 723 indicates a higher discount rate as compared with the privilege content 733. This increases the possibility that a certain number of users who are going to move in one of the directions D1 and D2 drop by at the bar B or the souvenir shop C before going to the nearest station 610. Therefore, concentration of the users on the nearest station 610 can be reduced for both the direction D1 and the direction D2. In particular, the possibility that more users who are going to move in the direction D1 stays at such commercial facilities for longer times increases as compared with the users who are going to move in the direction D2. Therefore, time zones in which the users concentrate are dispersed for the direction D1 and the direction D2, and the congestion can be further alleviated.

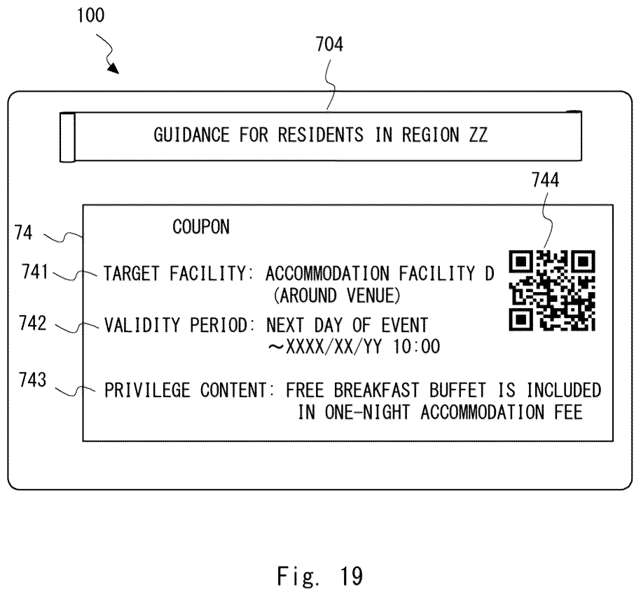

FIG. 19 is a diagram illustrating a display example of privilege information according to the third example embodiment. Although a notification message 704 indicates “guidance for residents in region ZZ”, the notification message 704 is not limited thereto. A coupon 74 displays a target facility 741, a validity period 742, privilege content 743, and code information 744. The target facility 741 indicates an accommodation facility D (the commercial facility 44, for example) around the event venue 40, and the validity period 742 indicates “until 10:00 am on the next day of the event”. The privilege content 743 indicates free breakfast buffer included in one-night fee.

For example, regions of residence are specified from the travel directions, the addresses, and the like of the users, and in a case where the degrees of congestion are equal to or greater than a predetermined value, staying at an accommodation in the neighborhood of the event venue 40 instead of going back home on the day of the event is proposed to users in further regions of residence. At this time, if there are more advantages for the users such as discount on a breakfast fee as compared with a usual accommodation fee, it is possible to send customers to the accommodation facility while avoiding congestion. This can also further alleviate congestion after the end of the event.

Note that each of the code information 724, 734, and 744 is a two-dimensional code including the privilege ID of the corresponding coupon. Also, the target facilities 721, 731, and 741, the validity periods 722, 732, and 742, the privilege content 723, 733, and 742, and the code information 724, 734, and 744 are examples and are not limited thereto.

### Fourth Example Embodiment

A fourth example embodiment is a modified example of the second or third example embodiment described above. An issuing unit according to the fourth example embodiment issues privilege information that can be used after a start of an event and from a second time before a scheduled end time of the event. Also, a notification unit provides a notification of the issued privilege information at a timing between a time after the start of the event and the second time before the scheduled end time of the event. In other words, the privilege information issuing apparatus 300 may provide the notification of the issued privilege information at least during the time on which the event is held. Note that an overall configuration and an individual configuration of the privilege information issuing system 1000 according to the fourth example embodiment are similar to those of the second example embodiment described above, and repeated description and illustration will thus be omitted.

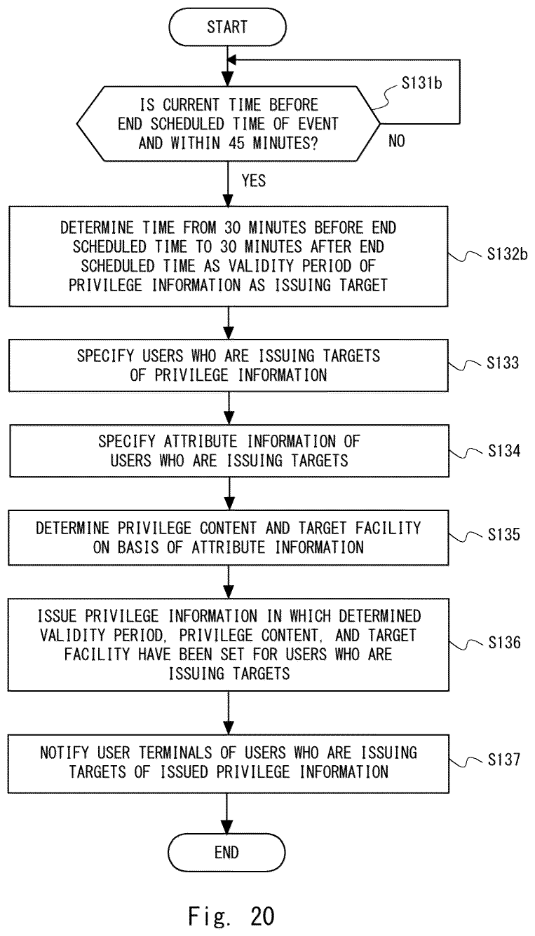

FIG. 20 is a flowchart illustrating a flow of privilege information issuing processing according to the fourth example embodiment. Although a second time is assumed to be 30 minutes in the following example, the second time is not limited thereto. First, the privilege information issuing apparatus 300 determines whether or not the current time is before the scheduled end time of the event and within 45 minutes (S131b). In a case where the current time is before 45 minutes before the scheduled end time of the event, the privilege information issuing apparatus 300 waits for a predetermined time and then executes Step S131b again.

In a case where the current time is within 45 minutes of the scheduled end time of the event, the privilege information issuing apparatus 300 determines the time from 30 minutes before the scheduled end time to 30 minutes after the scheduled end time as the validity period of the privilege information as an issuing target (S132b). In other words, privilege information that can be used in a short time before the end of the event is issued. Thereafter, Steps S133 to S137 described above are executed.

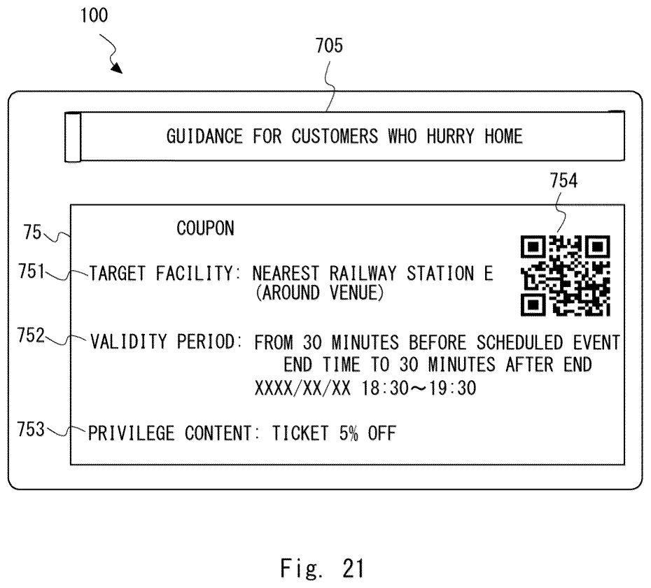

FIG. 21 is a diagram illustrating a display example of privilege information according to the fourth example embodiment. Although a notification message 705 indicates “guidance for customers who hurry home”, the notification message 705 is not limited thereto. A coupon 75 displays a target facility 751, a validity period 752, privilege content 753, and code information 754. The target facility 751 indicates the nearest station E (for example, the nearest station 610) of the train around the event venue 40, and the validity period 752 indicates a period from 30 minutes before the scheduled end time of the event to 30 minutes after the end. In this example, the scheduled end time of the event is set to 19:00, and the validity period is from 18:30 to 19:30 on the day of the event. The privilege content 753 indicates a ticket 5% off. The code information 754 is a two-dimensional code including the privilege ID. Note that the target facility 751, the validity period 752, the privilege content 753, and the code information 754 are examples and are not limited thereto.

In this manner, since the railway utilization fee from the nearest station 610 is discounted in the above example, it is possible to encourage the users who desired to avoid congestion after the end of the event to leave the event venue 40 early. Therefore, there is a possibility that congestion after the end of the event can be further alleviated.

Note that “45 minutes” in Step S131b in FIG. 20 described above is merely an example of the timing between the start of the event and the second time. In addition, the second time “30 minutes” is also merely an example. Therefore, in a case where the event is a baseball game, for example, the privilege information issuing apparatus 300 may determine whether or not a team taking the field first is wining by a big margin at the timing on which the bottom of the eighth inning ends. In this case, there may be users who will go home early without waiting for the end of the game (the top of the ninth inning), and it may be possible to present privilege information that can be used early, to thereby encourage the user to go home before the end of the game, and to further alleviate congestion after the end of the game.

### Fifth Example Embodiment

A fifth example embodiment is a modified example of the second, third, or fourth example embodiment described above. A vent according to the fifth example embodiment is a sport game, and an issuing unit specifies a support target of a user in the sport game on the basis of attribute information and issues privilege information on the basis of the specified support target. Furthermore, it is only necessary for the issuing unit to issue the privilege information in consideration of a relationship between the specified support target and a result of the sport game. Also the attribute information may include seat information for watching the sport game, and the issuing unit may specify the support target of the user from the seat information. Alternatively, the attribute information may include a method of purchasing entry qualification information for the sport game, and the issuing unit may specify the support target of the user from the purchasing method. Alternatively, the user terminal may display an input field for a support target team or player on the registration screen for the user information (member information) or the entry qualification information, include the support target input by the user in the attribute information, and transmit a registration request to the privilege information issuing apparatus 300. Note that an overall configuration and an individual configuration of the privilege information issuing system 1000 according to the fifth example embodiment are similar to those of the second example embodiment described above, and repeated description and illustration will thus be omitted.

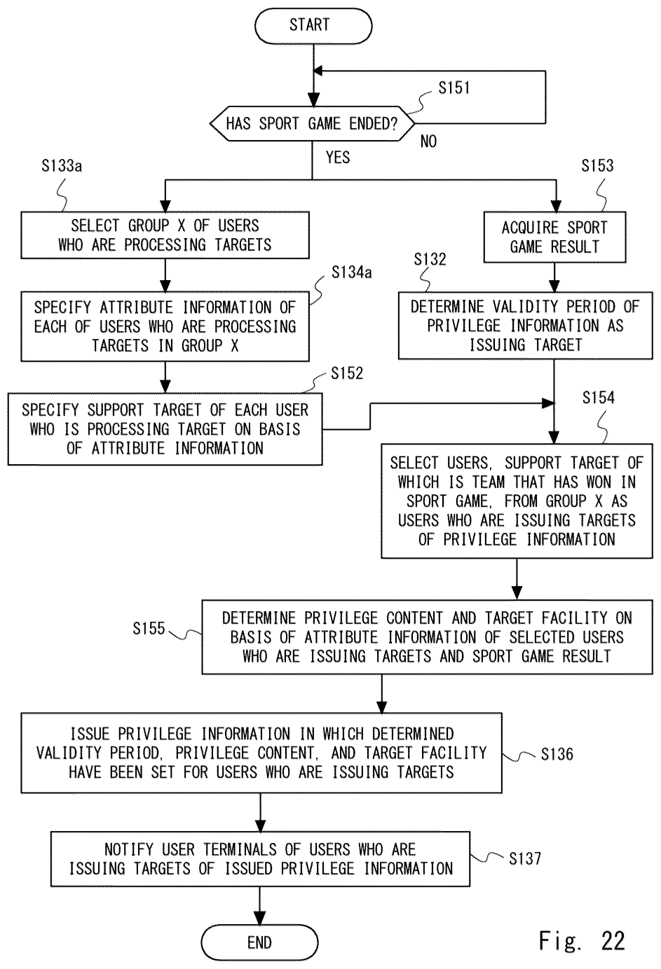

FIG. 22 is a flowchart illustrating a flow of privilege information issuing processing according to the fifth example embodiment. First, the privilege information issuing apparatus 300 determines whether or not the sport game which is the event has ended (S151). For example, it is possible to realize the determination by replacing the event end notification in Step S131 in FIG. 13 described above with a sport game end notification. Note that in a case where it is determined that the event has not ended, the privilege information issuing apparatus 300 waits for a predetermined time and then executes Step S151 again.

In a case where it is determined in Step S151 that the sport game has ended, the privilege information issuing apparatus 300 executes Steps S133a and S134a in FIG. 15 described above. Then, the privilege information issuing apparatus 300 specifies a support target of each user who is the processing target on the basis of the attribute information specified in Step S134a (S152). In a case where the attribute information 3123 includes a support target of a sport player or a team, for example, the privilege information issuing apparatus 300 specifies the support target from the attribute information 3123. Alternatively, the privilege information issuing apparatus 300 may specify the support target by estimating the support target from information indicating a hobby, a preference, or an interest in the attribute information 3123. Alternatively, in a case where the entry qualification information associated with the attribute information includes seat information for watching the sport game, the privilege information issuing apparatus 300 may specify the support target of the user from the seat information. In a case where the seat of a baseball stadium is on the third base side or the left stand, for example, the first-batting team may be specified as the support target. Also, in a case where the user is estimated to be a fan of a specific player from the attribute information, the team to which the player belongs may be regarded as the support target. Alternatively, in a case of an individual sport, the player specified from the attribute information may be regarded as the support target.

Alternatively, in a case where a method of purchasing the entry qualification information for the sport game is included in association with the attribute information, the privilege information issuing apparatus 300 may specify the support target of the user from the purchasing method. The “method of purchasing the entry qualification information for the sport game” is, for example, a dedicated application or a dedicated website for fans provided by a specific team, and it is assumed that the user U1 has purchased the ticket for the sport game via the dedicated application installed in the user terminal 100 or the dedicated website. Then, the attribute information or the entry qualification information may include records of the dedicated application used for the purchasing or the dedicated site through which the purchase has been made. In these cases, the privilege information issuing apparatus 300 may specify the dedicated application or the like from the attribute information or the entry qualification information or the purchase history information associated with the attribute information and specify the team corresponding to the dedicated application or the like as the support target.

Also, in a case where it is determined in Step S151 that the sport game has ended, the privilege information issuing apparatus 300 acquires a sport game result (S153). For example, the privilege information issuing apparatus 300 may acquire win and lose results of the sport game along with the sport game end notification described above. Then, the privilege information issuing apparatus 300 determines the validity period of the privilege information as the issuing target similarly to Step S132 described above. For example, the privilege information issuing apparatus 300 may set the validity period of the privilege information for the users, the support target of which is the winning team, to 4 hours and set the validity period of the privilege information for the users, the support target of which is the losing team, to 1 hour.

After Steps S152 and S132, the privilege information issuing apparatus 300 selects the users, the support target of which is the team that has won in the sport game, from the group X as the users who are issuing targets of the privilege information (S154). Note that the privilege information issuing apparatus 300 may also select the users, the support target of which is the team that has lost in the sport game, as the users who are issuing targets. Also, in a case of an individual sport, the privilege information issuing apparatus 300 may select users, the support target of which is a player who has won or lost in the sport game, as the users who are the issuing targets of the privilege information.

Then, the privilege information issuing apparatus 300 determines privilege content and a target facility on the basis of attribute information of the selected users who are the issuing targets and the sport game result (S155). For example, the privilege information issuing apparatus 300 may determine the privilege content and the target facility on the basis of the attribute information similarly to Step S135a described above and further change the privilege content and the target facility in accordance with the sport game result. For example, different target facilities may be assigned for the wining team and the losing team. Furthermore, in a case where the sport game result shows a large margin, privilege content that is more advantageous (a higher discount rate or the like) than usual may be granted to the user, the support target of which is the winning team. Thereafter, the privilege information issuing apparatus 300 executes Steps S136 and S137 described above.

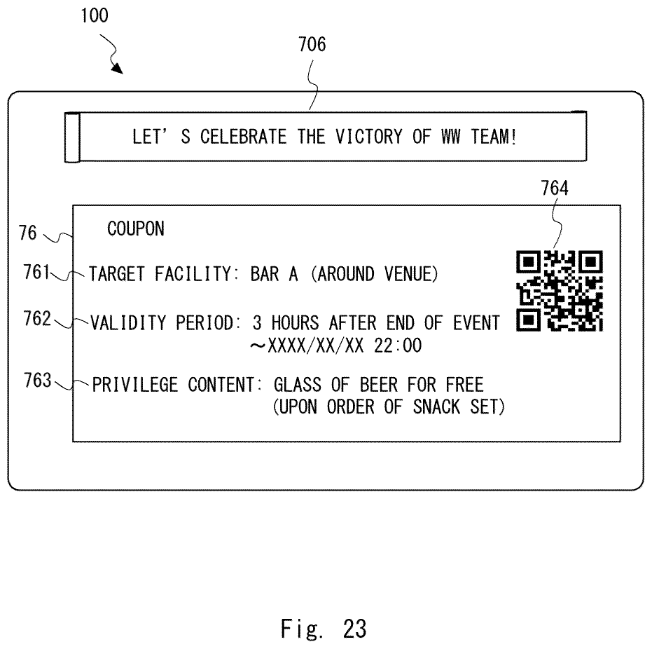

FIG. 23 is a diagram illustrating a display example of privilege information according to the fifth example embodiment. Although a notification message 706 indicates “let's celebrate the victory of WW team!”, the notification message 706 is not limited thereto. A coupon 76 displays a target facility 761, a validity period 762, privilege content 763, and code information 764. The target facility 761 indicates a bar A (the commercial facility 41, for example) around the event venue 40, and the validity period 762 indicates three hours after the end of the event. The privilege content 763 indicates that a glass of beer will be provided for free (upon an order of a snack set). The code information 764 is a two-dimensional code including the privilege ID. Note that the target facility 761, the validity period 762, the privilege content 763, and the code information 764 are examples and are not limited thereto.

In this manner, the users who have supported the winning team stay relatively long in the commercial facility 41 or the like, and it becomes easy to disperse the time zone of concentration at the nearest station 610 with the users who have supported the losing team. Therefore, congestion can be further alleviated.

### Sixth Example Embodiment

A sixth example embodiment is a modified example of the second to fifth example embodiments described above.

An issuing unit according to the sixth example embodiment issues privilege information on the basis of a ratio between the number of users who have entered an event venue through identity authentication and the number of users who have entered the event venue without identity authentication. Note that an overall configuration and an individual configuration of the privilege information issuing system 1000 according to the sixth example embodiment are similar to those of the second example embodiment described above, and repeated description and illustration will thus be omitted.

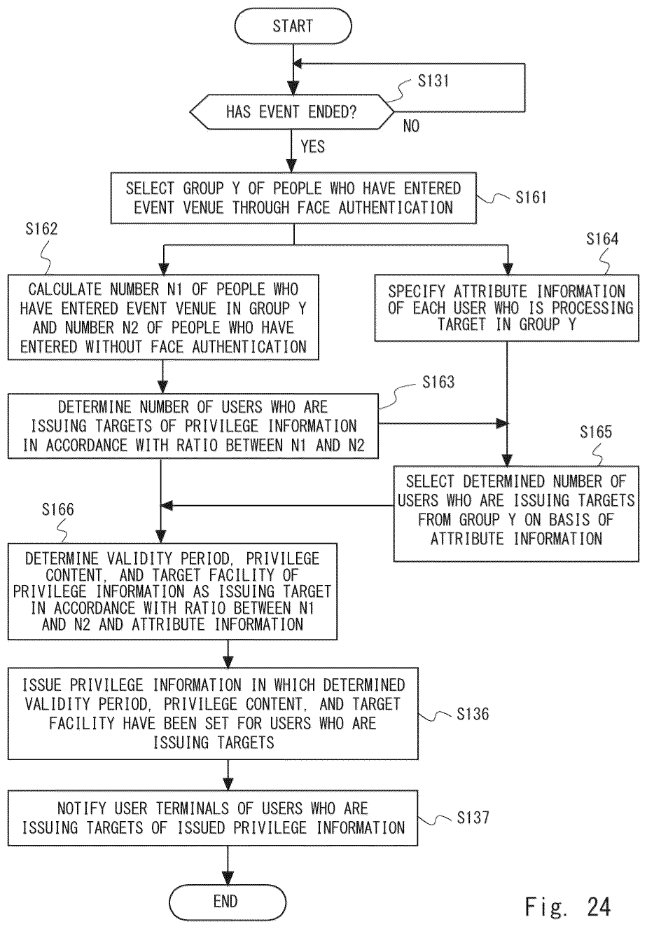

FIG. 24 is a flowchart illustrating a flow of privilege information issuing processing according to the sixth example embodiment. First, the privilege information issuing apparatus 300 executes Step S131 similarly to FIG. 13 described above. In a case where it is determined that the event has ended, the privilege information issuing apparatus 300 selects a group Y of users who have entered through face authentication (S161). Specifically, the privilege information issuing apparatus 300 refers to user information 312, selects users ID of the users who have the entry qualification information and have actually entered the event venue (before exiting the event venue) similarly to Step S133 described above, and regards a list of the selected user IDs as the group Y.

Then, the privilege information issuing apparatus 300 calculates the number N1 of people who have entered and the number N2 of people who have entered without face authentication in the group Y (S162). For example, the privilege information issuing apparatus 300 refers to user information 312 and calculates the number of users U1-1 to U1-m as N1. Moreover, the privilege information issuing apparatus 300 may acquire the number of users U4-1 to U4-k who have purchased conventional tickets or the like and have entered the event venue 40 without identity authentication at an entry control terminal 401 from a management server of an event organizer and perform calculation using the number as N2.

Then, the privilege information issuing apparatus 300 determines the number of users who are issuing targets from the privilege information in accordance with the ratio between N1 and N2 (S163). For example, the privilege information issuing apparatus 300 may determine 80% of the number N1 as the number of users who are issuing targets in a case where the ratio between N1 and N2 is 4:6, and the privilege information issuing apparatus 300 may determine about 60% of the number N1 as the number of users who are issuing targets in a case where the ratio is 8:2. Furthermore, the privilege information issuing apparatus 300 may determine the entire number N1 as the number of users who are issuing targets in a case where the total number of N1 and N2 is equal to or greater than 10 thousands and the proportion of N1 occupying the total number is equal to or greater than 40%.

Also, the privilege information issuing apparatus 300 specifies attribute information of each user who is the processing target in the group Y similarly to Step S134 described above after Step S161 (S164). After Steps S163 and S164, the privilege information issuing apparatus 300 selects the determined number of users who are issuing targets from the group Y on the basis of the specified attribute information (S165). In a case where a part of the number N1 of users is determined as issuing targets in Step S163, for example, the privilege information issuing apparatus 300 may select the users who are issuing targets from the group Y depending on member ranks or the like in the attribute information of the users.

After Steps S163 and S165, the privilege information issuing apparatus 300 determines a validity period, privilege content, and a target facility of the privilege information as an issuing target in accordance with the ratio between N1 and N2 and the attribute information (S166). Thereafter, the privilege information issuing apparatus 300 executes Steps S136 and S137 described above.

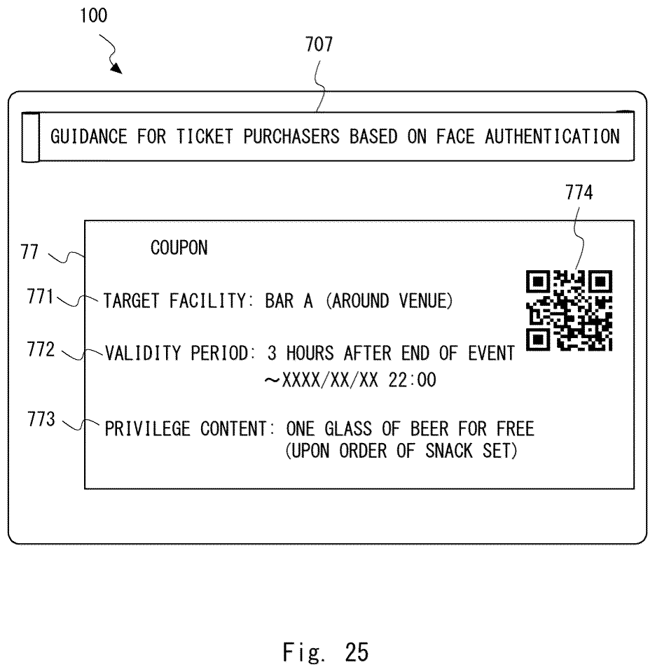

FIG. 25 is a diagram illustrating a display example of privilege information according to the sixth example embodiment. Although a notification message 707 indicates “guidance for ticket purchasers based on face authentication”, the notification message 707 is not limited thereto. A coupon 77 displays a target facility 771, a validity period 772, privilege content 773, and code information 774. The target facility 771 indicates a bar A (the commercial facility 41, for example) around the event venue 40, and the validity period 772 indicates three hours after the end of the event. The privilege content 773 indicates that a glass of beer will be provided for free (upon an order of a snack set). The code information 774 is a two-dimensional code including the privilege ID. Note that the target facility 771, the validity period 772, the privilege content 773, and the code information 774 are examples and are not limited thereto.

Even if identity authentication such as face authentication will be distributed in the future, there may be some users who cannot previously register identity authentication information such as face images for some reasons, and an operation assuming both the case where the identity authentication is used and the case where the identity authentication is not used as methods for entry to the event venue is thus conceivable. According to the example embodiment, it is possible to determine appropriate number of users, validity period, privilege content, and target facility in accordance with the ratio of the numbers of people who use or do not use the identity authentication, to issue privilege information, and to provide notifications even in such a case. Therefore, it becomes easy to disperse the time zones of concentration on the nearest station 610, and congestion can be further alleviated.

### Other Example Embodiments

Note that the aforementioned example embodiments have been described on the assumption that the identity authentication is based on the face authentication, the present disclosure is not limited thereto. In addition, although the description has been made on the assumption that the payment processing is based on the face authentication payment, the present disclosure may be applied to another payment method. In addition, the identity authentication at the time of issuing of the privilege information, the identity authentication at the time of entry or exiting of the event venue, and the identity authentication at the time of utilization of the privilege information in the commercial facility in the neighborhood of the event venue are also not limited to face authentication, and other identity authentication, which will be described later, may be applied.

In addition, although the aforementioned embodiments have been described on the assumption that the identity authentication (authentication for checking the identity, identity specification processing, and the like) is based on the face authentication, other biometric authentication using biometric information may also be performed. As the biometric authentication and the biometric information, other technologies using a captured image of a person can be applied. For example, as the biometric information, data (feature amount) calculated from physical characteristics unique to an individual such as a fingerprint, a voiceprint, a vein, a retina, an iris of a pupil, and a pattern (pattern) of a palm may be used. For the biometric authentication, feature information indicating the physical characteristics of a person may be extracted from the captured image of a part of the body of the user, the extracted feature information may be collated with feature information registered in advance, and the authentication may be regarded as being successful if the degree of matching is equal to or greater than the threshold value. For example, the biometric authentication may be authentication based on the appearance shape of the person. In this case, the feature information is information regarding the appearance shape of the person, for example, information indicating features such as a body shape, a height, and clothes. In addition, instead of the biometric authentication, another identity authentication may be applied, and the biometric information may also be another identity authentication information. Examples of the identity authentication information include, but are not limited to, a combination of a user ID, an ID, and a password, description contents (an identification number and the like or a password) of an identification card such as an individual number and a driver's license, an electronic certificate, code information, and the like. The code information may be a two-dimensional code, for example, a QR code (registered trademark).

Note that although the second example embodiment and the like are described on the assumption that the authentication apparatus 200 and the privilege information issuing apparatus 300 are different information processing apparatuses, the authentication apparatus 200 and the privilege information issuing apparatus 300 may be the same information processing apparatus. For example, the privilege information issuing apparatus 300 may further register the face feature information in association with the user ID 3121 of the user information 312. In this case, the control unit 340 only needs to further have the functions of the face detection unit 220, the feature point extraction unit 230, the registration unit 240, and the authentication unit 250 in FIG. 4.

Note that the issuing condition, the issuing timing, and the notification timing of the privilege information are not limited to those described above. For example, the issuing timing and the notification timing are not limited to just before the end of the event and may be during the event or before the start of the event. In other words, the notification unit may provide a notification of the issued privilege information at a timing of a third time before the scheduled end time of the event.
(1) In a case where the “third time” is shorter than a time during which the event is held, the notification timing of the privilege information is during the event. Specifically, the privilege information issuing apparatus 300 may specify the users of the user IDs who have entry qualification information and have already entered the event venue on the day of the event as users who are issuing targets, issue privilege information, and notify the user of the privilege information during the time on which the event is held, similarly to the fourth example embodiment described above. In a case where the time during which the event is held is from 13:00 to 15:00, for example, the privilege information issuing apparatus 300 may notify the users “from 13:00 to 15:00”, which is the time during which the event is going on, of the privilege information. Note that the privilege information issuing apparatus 300 may acquire booking or purchasing information of event tickets, calculate the number of purchasers for each type of the tickets, and determine the number of users who are issuing targets.
(2) In a case where the “third time” is longer than a time during which the event is held, the notification timing of the privilege information is before the start of the event. Specifically, the privilege information issuing apparatus 300 specifies the users of the user IDs who have entry qualification information and have not yet entered the event venue as the users who are issuing targets at the time of purchasing or registering the entry qualification information or at a predetermined time before the event start time. Then, the privilege information issuing apparatus 300 issues the privilege information for the users who are issuing targets and notifies user terminals of the users who are issuing targets of the privilege information at least at the predetermined time before the event start time. In a case where the time during which the event is held is from 13:00 to 15:00, for example, the privilege information issuing apparatus 300 may notify the users “before 13:00” which is the timing before the start of the event of the privilege information. Note that the privilege information issuing apparatus 300 may acquire ticket booking or advance ticket purchasing information for the event, calculate the number of purchasers for each type of the tickets, and determine the number of users who are issuing targets.

Note that it is only necessary for the issuing timing of the privilege information to be before the notification timing. In other words, the privilege information issuing apparatus 300 may issue the privilege information before the start of the event and notify the terminals of the users who are issuing targets of the privilege information that has already been issued after the start of the event and before the end of the event. In a case where the time during which the event is held is from 13:00 to 15:00, for example, the privilege information issuing apparatus 300 may issue the privilege information “before 13: '00” and notify the users “from 13:00 to 15:00” of the privilege information. Also, a utilization start timing of the privilege information may come later than the notification timing. For example, even if the notification of the coupon is provided before the start of the event or during the event, the start of the utilization of the coupon may be after the end of the event (or after elapse of a predetermined time after the end). For example, the privilege information issuing apparatus 300 may notify the user “before 15:00” which is the event end time of the privilege information, and the start of the utilization of the privilege information may be “after 15:00 (or after elapse of a predetermined time after 15:00)”. Alternatively, even if the notification of the coupon is provided before the start of the event or within 30 minutes after the start of the event, the start of the utilization of the coupon may be 30 minutes before the event end time or the event scheduled end time. For example, the start of the utilization of the privilege information may be “after 15:00” or “30 minutes before 15:00”.

Note that the privilege information issuing apparatus 300 may narrow down the users who are issuing targets in accordance with the types of the tickets (such as seat grades), the number of purchased tickets of each type, the number of persons who have made reservations, and the like.

Note that in the entry qualification information registration processing in FIG. 11 described above, the entry qualification information may not necessarily be registered using the success in face authentication as a condition. Alternatively, in a case where the user ID issued at the time of registration of the user information is stored in the user terminal, the user terminal may transmit a registration request including the user ID and the entry qualification information instead of the face image to the privilege information issuing apparatus 300 in Step S123. In that case, the privilege information issuing apparatus 300 may register the user ID and the entry qualification information included in the received registration request in an associated manner in user information. Alternatively, a sales server of the entry qualification information may transmit a registration request including the user ID and the entry qualification information of the purchaser to the privilege information issuing apparatus 300 at the time of purchasing the entry qualification information, and cause the privilege information issuing apparatus 300 to register the user ID and the entry qualification information.

Note that the entry qualification information registration processing in FIG. 11 described above may be performed by an information registration terminal instead of the user terminal 100. The information registration terminal may be, for example, a KIOSK terminal installed in a station or a commercial facility. In this case, the user terminal 100 transfers the entry qualification information to the KIOSK terminal, for example. Alternatively, the user inputs the entry qualification information to the KIOSK terminal. Then, the KIOSK terminal transmits the acquired entry qualification information and a face image obtained by imaging the user with the KIOSK terminal to the privilege information issuing apparatus 300. Note that in a case where a current location is used to issue the privilege information, the position information of the KIOSK terminal may be used. In addition, it is only necessary for the privilege information issuing apparatus 300 to notify the KIOSK terminal of the issued privilege information. At this time, the KIOSK terminal may display code information or the like of the privilege information such that the code information can be visually recognized by the user, and the user terminal may acquire the privilege information by scanning the code information displayed on the screen of the KIOSK terminal. Alternatively, the KIOSK terminal may print and output the code information or the like of the received privilege information. Alternatively, the privilege information issuing apparatus 300 may provide a notification of the privilege information issued with respect to the terminal information (user terminal) of the user specified by face authentication.

Note that the aforementioned issuing unit may select privilege information in accordance with attributes of the event, and issue and present the privilege information and notify the user of the privilege information. For example, in a case where the event is a sport game, a coupon that can be used at a support goods store may be issued to guide the user to the sales store. In addition, in a case where the event is a test, a coupon that can be used in a quiet cafe may be issued to guide the user to the cafe.

In the above-described example, the program includes a group of instructions (or software code) for causing a computer to perform one or more functions described in the example embodiments if the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### Supplementary Note A1

A privilege information issuing apparatus including:
an issuing means for setting a validity period based on an end time of a predetermined event and issuing privilege information that is able to be used in facilities in a neighborhood of an event venue where the event has been held; and
a notification means for notifying a terminal of a user who has entered the event venue through identity authentication of the issued privilege information at a timing that is attributable to the end time.

### Supplementary Note A2

The privilege information issuing apparatus according to Supplementary Note A1, in which the issuing means issues the privilege information for which a first time after the end time is set as the validity period.

### Supplementary Note A3

The privilege information issuing apparatus according to Supplementary Note A1 or A2, in which
the issuing means issues the privilege information that is able to be used after a start of the event and from a second time before a scheduled end time of the event, and
the notification means provides a notification of the issued privilege information at a timing between a time after the start of the event and the second time before the scheduled end time of the event.

### Supplementary Note A4

The privilege information issuing apparatus according to any one of Supplementary Notes A1 to A3, in which the notification means provides a notification of the issued privilege information at a timing of a third time before the scheduled end time of the event.

### Supplementary Note A5

The privilege information issuing apparatus according to any one of Supplementary Notes A1 to A4, in which the issuing means issues the privilege information in accordance with attribute information associated with the user.

### Supplementary Note A6

The privilege information issuing apparatus according to Supplementary Note A5, in which
the issuing means
selects a user that is a target of issuing of the privilege information in accordance with attribute information associated with each of a plurality of users who has entered the event venue through the identity authentication, and
issues the privilege information for the selected user, and
the notification means notifies a terminal of the selected user of the issued privilege information.

### Supplementary Note A7

The privilege information issuing apparatus according to Supplementary Note A5 or A6, in which
the issuing means
specifies a travel direction after the event on the basis of the attribute information for each of the plurality of users,
estimates, for each travel direction, a degree of congestion of at least one of a road or a transportation facility around the event venue on the basis of the number of users in the specified travel direction, and
selects a user in a travel direction, for which the estimated congestion degree is equal to or greater than a predetermined value, as a target of issuing of the privilege information from among the plurality of users.

### Supplementary Note A8

The privilege information issuing apparatus according to Supplementary Note A7, in which the issuing means further considers operating information of a nearest transportation facility from the event venue for each direction and estimates a congestion degree of the transportation facility.

### Supplementary Note A9

The privilege information issuing apparatus according to any one of Supplementary Notes A5 to A8, in which the issuing means issues the privilege information granting privilege content in accordance with the attribute information.

### Supplementary Note A10

The privilege information issuing apparatus according to any one of Supplementary Notes A5 to A9, in which the issuing means issues the privilege information that is able to be used at different facilities depending on the attribute information from among the facilities in the neighborhood.

### Supplementary Note A11

The privilege information issuing apparatus according to any one of Supplementary Notes A5 to A10, in which
the event is a sport game, and
the issuing means specifies a support target of the user in the sport game on the basis of the attribute information and issues the privilege information on the basis of the specified support target.

### Supplementary Note A12

The privilege information issuing apparatus according to Supplementary Note A11, in which the issuing means issues the privilege information in consideration of a relationship between the specified support target and a result of the sport game.

### Supplementary Note A13

The privilege information issuing apparatus according to Supplementary Note A11 or A12, in which
the attribute information includes seat information regarding watching of the sport game, and
the issuing means specifies the support target of the user from the seat information.

### Supplementary Note A14

The privilege information issuing apparatus according to Supplementary Note A11 or A12,
in which the attribute information includes a method of purchasing entry qualification information for the sport game, and
the issuing means specifies the support target of the user from the method of purchasing.

### Supplementary Note A15

The privilege information issuing apparatus according to any one of Supplementary Notes A1 to A14, in which the issuing means issues the privilege information on the basis of a ratio between the number of users who have entered the event venue through the identity authentication and the number of users who have entered the event venue without the identity authentication.

### Supplementary Note B1

A privilege information issuing system including:
a storage apparatus that stores entry qualification information with which a user is able to enter an event venue through identity authentication, identity authentication information of the user who has purchased the entry qualification information, and a user terminal that the user carries with himself/herself in an associated manner; and
a privilege information issuing apparatus that is connected to the storage apparatus,
in which the privilege information issuing apparatus includes
an issuing means for setting a validity period based on an end time of a predetermined event and issuing privilege information that is able to be used in facilities in a neighborhood of the event venue where the event has been held, and
a notification means for notifying a user terminal associated with the user who has entered the event venue through identity authentication performed with reference to the storage apparatus of the issued privilege information at a timing that is attributable to the end time.

### Supplementary Note B2

The privilege information issuing system according to Supplementary Note B1, in which the issuing means issues the privilege information for which a first time after the end time is set as the validity period.

### Supplementary Note C1

A privilege information issuing method including, by a computer:
setting a validity period based on an end time of a predetermined event and issuing privilege information that is able to be used in facilities in a neighborhood of an event venue where the event has been held; and
notifying a terminal of a user who has entered the event venue through identity authentication of the issued privilege information at a timing that is attributable to the end time.

### Supplementary Note D1

A non-transitory computer-readable medium that stores a privilege information issuing program that causes a computer to execute:
an issuing means for setting a validity period based on an end time of a predetermined event and issuing privilege information that is able to be used in facilities in a neighborhood of an event venue where the event has been held; and
a notification means for notifying a terminal of a user who has entered the event venue through identity authentication of the issued privilege information at a timing that is attributable to the end time.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### Reference Signs List

1 PRIVILEGE INFORMATION ISSUING APPARATUS
11 ISSUING UNIT
12 NOTIFICATION UNIT
1000 PRIVILEGE INFORMATION ISSUING SYSTEM
N NETWORK
U1 USER
U1-1 to U1-m USER
U4 USER
U4-1 to U4-k USER
U21 FACILITY STAFF
U2n FACILITY STAFF
U3 AREA STAFF
100 USER TERMINAL
110 STORAGE UNIT
111 PROGRAM
112 TERMINAL INFORMATION
120 MEMORY
130 COMMUNICATION UNIT
140 CAMERA
150 TOUCH PANEL
160 CONTROL UNIT
161 REGISTRATION UNIT
162 PRIVILEGE PROCESSING UNIT
200 AUTHENTICATION APPARATUS
210 FACE INFORMATION DB
211 USER ID
212 FACE FEATURE INFORMATION
220 FACE DETECTION UNIT
230 FEATURE POINT EXTRACTION UNIT
240 REGISTRATION UNIT
250 AUTHENTICATION UNIT
300 PRIVILEGE INFORMATION ISSUING APPARATUS
310 STORAGE UNIT
311 PROGRAM
312 USER INFORMATION
3121 USER ID
3122 TERMINAL INFORMATION
3123 ATTRIBUTE INFORMATION
3124 PAYMENT INFORMATION
3125 ENTRY QUALIFICATION INFORMATION
313 PRIVILEGE INFORMATION MASTER
3131 PRIVILEGE ID
3132 TARGET FACILITY
3133 PRIVILEGE CONTENT
3134 ISSUING CONDITION
314 EVENT INFORMATION
315 PRIVILEGE MANAGEMENT INFORMATION
3151 ISSUED PRIVILEGE ID
3152 USER ID
3153 ISSUING DATE AND TIME
3154 VALIDITY PERIOD
3155 TARGET FACILITY
3156 PRIVILEGE CONTENT
320 MEMORY
330 COMMUNICATION UNIT
340 CONTROL UNIT
341 REGISTRATION UNIT
342 AUTHENTICATION CONTROL UNIT
343 SPECIFICATION UNIT
344 ISSUING UNIT
345 NOTIFICATION UNIT
346 ENTRY DETERMINATION UNIT
347 PAYMENT CONTROL UNIT
4 AREA
40 EVENT VENUE
401 ENTRY CONTROL TERMINAL
402 EVENT HALL
41 COMMERCIAL FACILITY
51 PAYMENT TERMINAL
61 MANAGEMENT TERMINAL
4n COMMERCIAL FACILITY
5n PAYMENT TERMINAL
6n MANAGEMENT TERMINAL
600 MANAGEMENT TERMINAL
610 NEAREST STATION
410 STORAGE UNIT
411 PROGRAM
412 TERMINAL INFORMATION
420 MEMORY
430 COMMUNICATION UNIT
440 CAMERA
450 TOUCH PANEL
460 CONTROL UNIT
461 RECEPTION UNIT
462 ENTRY CONTROL UNIT
510 STORAGE UNIT
511 PROGRAM
512 TERMINAL INFORMATION
520 MEMORY
530 COMMUNICATION UNIT
540 CAMERA
550 TOUCH PANEL
560 CONTROL UNIT
561 RECEPTION UNIT
562 PAYMENT CONTROL UNIT
701 NOTIFICATION MESSAGE
71 COUPON
711 TARGET FACILITY
712 VALIDITY PERIOD
713 PRIVILEGE CONTENT
714 CODE INFORMATION
702 NOTIFICATION MESSAGE
72 COUPON
721 TARGET FACILITY
722 VALIDITY PERIOD
723 PRIVILEGE CONTENT
724 CODE INFORMATION
703 NOTIFICATION MESSAGE
73 COUPON
731 TARGET FACILITY
732 VALIDITY PERIOD
733 PRIVILEGE CONTENT
734 CODE INFORMATION
704 NOTIFICATION MESSAGE
74 COUPON
741 TARGET FACILITY
742 VALIDITY PERIOD
743 PRIVILEGE CONTENT
744 CODE INFORMATION
705 NOTIFICATION MESSAGE
75 COUPON
751 TARGET FACILITY
752 VALIDITY PERIOD
753 PRIVILEGE CONTENT
754 CODE INFORMATION
706 NOTIFICATION MESSAGE
76 COUPON
761 TARGET FACILITY
762 VALIDITY PERIOD
763 PRIVILEGE CONTENT
764 CODE INFORMATION
707 NOTIFICATION MESSAGE
77 COUPON
771 TARGET FACILITY
772 VALIDITY PERIOD
773 PRIVILEGE CONTENT
774 CODE INFORMATION

What is claimed is:

1. A privilege information issuing apparatus comprising:
at least one storage device configured to store instructions; and
at least one processor configured to execute the instructions to:
set a validity period based on an end time of a predetermined event and issue privilege information that is able to be used in facilities in a neighborhood of an event venue where the event has been held; and
notify a terminal of a user who has entered the event venue through identity authentication of the issued privilege information at a timing that is attributable to the end time.

2. The privilege information issuing apparatus according to claim 1, wherein the at least one processor is further configured to execute the instructions to:
issue the privilege information for which a first time after the end time is set as the validity period.

3. The privilege information issuing apparatus according to claim 1, wherein the at least one processor is further configured to execute the instructions to:
issue the privilege information that is able to be used after a start of the event and from a second time before a scheduled end time of the event, and
provide a notification of the issued privilege information at a timing between a time after the start of the event and the second time before the scheduled end time of the event.

4. The privilege information issuing apparatus according to claim 1, wherein the at least one processor is further configured to execute the instructions to:
provide a notification of the issued privilege information at a timing of a third time before the scheduled end time of the event.

5. The privilege information issuing apparatus according to claim 1, wherein the at least one processor is further configured to execute the instructions to:
issue the privilege information in accordance with attribute information associated with the user.

6. The privilege information issuing apparatus according to claim 5, wherein the at least one processor is further configured to execute the instructions to:
select a user that is a target of issuing of the privilege information in accordance with attribute information associated with each of a plurality of users who has entered the event venue through the identity authentication,
issue the privilege information for the selected user, and
notify a terminal of the selected user of the issued privilege information.

7. The privilege information issuing apparatus according to claim 5, wherein the at least one processor is further configured to execute the instructions to:
specify a travel direction after the event on the basis of the attribute information for each of the plurality of users,
estimate, for each travel direction, a degree of congestion of at least one of a road or a transportation facility around the event venue on the basis of the number of users in the specified travel direction, and
select a user in a travel direction, for which the estimated congestion degree is equal to or greater than a predetermined value, as a target of issuing of the privilege information from among the plurality of users.

8. The privilege information issuing apparatus according to claim 7, wherein the at least one processor is further configured to execute the instructions to:
consider operating information of a nearest transportation facility from the event venue for each direction and estimate a congestion degree of the transportation facility.

9. The privilege information issuing apparatus according to claim 5, wherein the at least one processor is further configured to execute the instructions to:
issue the privilege information granting privilege content in accordance with the attribute information.

10. The privilege information issuing apparatus according to claim 5, wherein the at least one processor is further configured to execute the instructions to:
issue the privilege information that is able to be used at different facilities depending on the attribute information from among the facilities in the neighborhood.

11. The privilege information issuing apparatus according to claim 5, wherein
the event is a sport game, and
wherein the at least one processor is further configured to execute the instructions to:
specify a support target of the user in the sport game on the basis of the attribute information and issue the privilege information on the basis of the specified support target.

12. The privilege information issuing apparatus according to claim 11, wherein the at least one processor is further configured to execute the instructions to:
issue the privilege information in consideration of a relationship between the specified support target and a result of the sport game.

13. The privilege information issuing apparatus according to claim 11, wherein
the attribute information includes seat information regarding watching of the sport game, and
wherein the at least one processor is further configured to execute the instructions to:
specify the support target of the user from the seat information.

14. The privilege information issuing apparatus according to claim 11, wherein
the attribute information includes a method of purchasing entry qualification information for the sport game, and
wherein the at least one processor is further configured to execute the instructions to:
specify the support target of the user from the purchasing method.

15. The privilege information issuing apparatus according to claim 1, wherein the at least one processor is further configured to execute the instructions to:
issue the privilege information on the basis of a ratio between the number of users who have entered the event venue through the identity authentication and the number of users who have entered the event venue without the identity authentication.

16. A privilege information issuing system comprising:
a storage apparatus that stores entry qualification information with which a user is able to enter an event venue through identity authentication, identity authentication information of the user who has purchased the entry qualification information, and a user terminal that the user carries with himself/herself in an associated manner; and
a privilege information issuing apparatus that is connected to the storage apparatus, and including:
at least one storage device configured to store instructions; and
at least one processor configured to execute the instructions to:
set a validity period based on an end time of a predetermined event and issue privilege information that is able to be used in facilities in a neighborhood of the event venue where the event has been held, and
notify a user terminal associated with the user who has entered the event venue through identity authentication performed with reference to the storage apparatus of the issued privilege information at a timing that is attributable to the end time.

17. The privilege information issuing system according to claim 16, wherein the at least one processor is further configured to execute the instructions to:
issue the privilege information for which a first time after the end time is set as the validity period.

18. A privilege information issuing method comprising, by a computer:
setting a validity period based on an end time of a predetermined event and issuing privilege information that is able to be used in facilities in a neighborhood of an event venue where the event has been held; and
notifying a terminal of a user who has entered the event venue through identity authentication of the issued privilege information at a timing that is attributable to the end time.

19. A non-transitory computer-readable medium that stores a privilege information issuing program that causes a computer to execute:
an issuing means for setting a validity period based on an end time of a predetermined event and issuing privilege information that is able to be used in facilities in a neighborhood of an event venue where the event has been held; and
a notification means for notifying a terminal of a user who has entered the event venue through identity authentication of the issued privilege information at a timing that is attributable to the end time.
